(19) United States
(12) Patent Application Publication
(10) Pub. No.: US 2017/0098382 A1
(43) Pub. Date: Apr. 6, 2017

(54) System and Method for Handwriting Instruction and Remediation

(71) Applicant: Handwriting Tree, LLC, North Potomac, MD (US)

(72) Inventors: Larry R. Miller, North Potomac, MD (US); Melissa L. Miller, North Potomac, MD (US)

(73) Assignee: Handwriting Tree, LLC, North Potomac, MD (US)

(21) Appl. No.: 14/874,375

(22) Filed: Oct. 2, 2015

(51) Int. Cl. G09B 11/04

(52) U.S. Cl. CPC G09B 11/04

(57) ABSTRACT

Systems and methods are provided for spatially-oriented handwriting instruction and remediation. A number of components are provided that maintain consistent instructional and visual cues, promoting continuity for blocked handwriting practice and incorporating elements to promote developmental hand skills.

### FIELD OF THE INVENTION

The invention relates to a system and method for assisting individuals with learning to write letters and numerals, in particular individuals who are having difficulty developing handwriting skills, such as autistic spectrum and other special needs individuals, such as those with intellectual disabilities.

### BACKGROUND

A handwritten product is the resulting confluence of several different skills including visual motor integration, cognition, working memory, motor planning, tactile sensation, and visual perceptual skills. In recent years, there has been much media chatter purporting the predicted extinction of this complex skill in favor of keyboarding. However, a plethora of evidence supports handwriting as a key academic component to the development of compositional fluency skills. Moreover, handwritten materials are more likely to be remembered than materials that had been composed using a keyboard. It has been documented that 60 percent of a child's school day is comprised of fine motor activities, with handwriting accounting for the majority of this time. Handwriting continues to be the primary way students present and demonstrate their knowledge.

Children with special needs, including those with Autism Spectrum Disorder (ASD) or intellectual disabilities, present with a unique set of educational requirements and challenges in the above mentioned skill areas. Children on the Autism Spectrum can also present with hand weakness, grip and pinch strength weakness, and difficulties with spatial skills. Sensory and motor difficulties result in impaired “joint attention,” which is defined as the ability to form a social connection to the instructor and/or handwriting task at hand. There is clear literature evidence that increasing grip and pinch strength in students with ASD has a positive effect on handwriting legibility.

Moreover, the relevant handwriting literature supports the use of “blocked practice,” that is practicing the actual skills of handwriting the same way, repeatedly for blocks of time. Handwriting instruction is further enhanced by presenting letters in order of difficulty, as well as frequency of use. Tracing using lined directional indicators has also been shown to facilitate letter formation skills. Furthermore, the use of a multisensory approach to learning is well supported in handwriting literature as well as in education in general. Joint attention, or student engagement, in a task is integral to the successful learning process.

Currently, no handwriting program exists that has been designed specifically to address the needs of students with ASD or who exhibit difficulty with spatial orientation. Many programs rely only on letter practice and/or tracing, or do not incorporate the use of directional indicators, which support consistency in letter formation. Consistent letter formation leads to improved legibility as well as speed of writing, which is an important factor in development of compositional fluency. Moreover, consistent learning using lined paper supports spatial orientation, letter formation, and legibility. Many students begin by writing very large letters and progress to smaller letters as they gain more mastery. There are currently no commercial systems available to teach handwriting that incorporates larger to smaller letter progression coupled with consistent line orientation and a framework for spatial orientation.

Keeping students engaged and interested is a major challenge encountered when implementing handwriting programs with this population. The use of a “social story” is well documented to increase engagement when developing a new social or life skill such as handwriting. In particular, the use of social stories enhances participation in instructional and practice sessions. Many currently available programs to promote handwriting fail to engage the student by using age-appropriate and engaging visuals and characters, which promote learning and fun.

Use of blocked practice that combines multisensory feedback is an important component of ASD handwriting instruction, as is providing large, lined paper with consistent properties across practice sessions. This practice supports having the student understand where to start the letter and where to stop writing, which reinforces motor control.

Some current programs employ the use of a blackboard to provide tracing practice, as well as proprioceptive feedback via the “feel” of the chalk on the board to reinforce sensory motor learning. The ASD population is unique in that many students have sensory systems that are highly attuned to environmental sounds, textures, and changes. Many occupational therapists have reported difficulty with handwriting instruction because ASD students can demonstrate chalkboard aversion resulting from the sounds created by the chalk writing on the board.

Moreover, this student population frequently becomes accustomed or highly acclimated to materials and routine. There are currently no handwriting instructional programs that include chalkboards that closely resemble writing paper in terms of the relative colors of the chalk and the background color of the board. Students with ASD often have difficultly transitioning from a system with white chalk on a dark chalkboard to white paper with a dark-colored writing implement (e.g. pencil, pen, or marker).

Unique to ASD students, as well as many young students with handwriting difficulties, is decreased grip and pinch strength. Lack of strength interferes with successful motor control as well as endurance for classroom writing assignments. Many currently available handwriting programs fail to address grip and pinch strength, which has been shown to be integral to successful writing.

Handwriting is a critical skill to successful school performance. Studies indicate students who write neatly receive higher marks and are perceived to have more compositional fluency. Furthermore, students who must constantly attend to handwriting issues are limited in their ability to expand compositionally, which may lead to an avoidance of writing altogether.

Many currently available products provide handwriting practice, although none are specifically directed to the ASD population. However, no previous product or system contributes to the educational field by combining all of the key features of successful handwriting training as described above from the scientific and social literature.

There is a need for a handwriting instructional system that addresses the problems described above.

### BRIEF SUMMARY OF THE INVENTION

Methods and systems are provided for handwriting instruction and practice. The methods and systems described herein employ materials with consistent instructional cues, and in some embodiments, thematic storytelling elements to engage the attention of the student. The methods and systems herein provide a multi-sensory approach to handwriting instruction and remediation.

In one aspect, a device is provided, for use in methods and systems for handwriting instruction and remediation as described herein, in the form of a “reverse chalkboard cassette,” that includes a writing surface having a top and a bottom, and further including, superimposed on the writing surface, a first solid line at the top or substantially at the top of the writing surface, a dashed line, and a second solid line, wherein the area between the first and second solid lines provide a first writing area, wherein the dashed line is located at an intermediate position between the first solid line and the second solid line, wherein the first solid line, the second solid line, and the dashed line are parallel or substantially parallel to each other, and wherein the writing surface is constructed of a material on which writing strokes, letters, or numerals may be formed with a writing implement, in a color that is darker than the color of the writing surface, and erased for reuse of the surface. In some embodiments, the writing surface further includes an orientation indicator. In some embodiments, the upper and/or lower solid line(s) may be raised from the surface of the reverse chalkboard cassette to provide a physical boundary for starting and/or stopping points for handwriting strokes.

In some embodiments, the first solid line, the second solid line, and the dashed line are different colors. Any color scheme may be employed, but in one embodiment, the first solid line is green and the second solid line is red. In one embodiment, the dashed line is brown.

In some embodiments, the writing surface is composed of a high-pressure laminate, such as a laminate material in accordance with European Standard EN 438 and ISO 4586. In other embodiments, the writing surface is composed of a painted surface or a printed sticker with a clear coating, for example, clear chalkboard paint, epoxy, lacquer, polyurethane, varnish, and/or other clear or protective finish.

In some embodiments, the second solid line is at the bottom or substantially at the bottom of the writing surface. Such an embodiment may provide a writing surface that is suitable for instruction or practice for writing upper case letters or numerals.

In some embodiments, the second solid line is located at an intermediate position between the dashed line and the bottom of the writing surface, and the writing surface includes a second writing area below the second solid line and extending to the bottom or substantially to the bottom of the writing surface. Such an embodiment may provide a writing surface that is suitable for instruction or practice for writing lower case letters. In some embodiments, the first writing area is a first color and the second writing is a second color. In some embodiments, the second writing area is a darker color than the first writing area. For example, the second writing area may be darker than the first writing area by a difference in Munsell values about 2 to about 4, or a difference of at least about 2, at least about 3, or at least about 4.

In some embodiments, the first writing area is white, substantially white, off-white, or cream color. In some embodiments, the second writing area is gray.

In some embodiments, the writing surface is configured within a raised surface and forms a recessed area within the raised surface. In one embodiment, the raised surface includes a frame that surrounds at least a portion of the writing surface or the entire writing surface.

In another aspect, a writing implement is provided that is capable of forming writing strokes, letters, or numerals on the writing surface of the reverse chalkboard cassette, in a color that is darker than the writing area, e.g., the writing area between the first and second solid lines of the reverse chalkboard cassette, by a difference in Munsell values of about 2 to about 8, about 2 to about 4, or about 4 to about 8 or a difference of at least about 2, at least about 3, or at least about 4, at least about 5, at least about 6, at least about 7, or at least about 8. In some embodiments, the reverse chalkboard cassette contains a first writing area that is a first color and a second writing area that is a second color, as described above, and the writing strokes, letters, or numerals formed by the writing implement are darker than the first writing area by a Munsell value difference of about 4 to about 8, or at least about 4, at least about 5, at least about 7, or at least about 8, and the writing strokes, letters, or numerals formed by the writing implement are darker than the second writing areas by a Munsell value difference of at least about 2 to at least about 4, or at least about 2, at least about 3, or at least 4. In some embodiments, the second writing area is darker than the first writing area by a Munsell value difference of about 2 to about 4, or at least about 2, at least about 3, or at least about 4, and the writing strokes, letters, or numerals formed by the writing implement are darker than the second writing area by a Munsell difference of about 2 to about 4, or at least about 2, at least about 3, or at least about 4. In some embodiments, the writing implement provides proprioceptive feedback when used to form writing strokes on the writing surface. In some embodiments, the first color is white, substantially white, off-white, or cream color, and the writing implement produces black or gray writing strokes. In some embodiments in which a second writing area is present, the first color is white, substantially white, off-white, or cream color, the second color is gray, and the writing implement produces black or gray writing strokes that are darker than the second writing area by a Munsell value of about 2 to about 4, or at least about 2, at least about 3, or at least about 4. In some embodiments, the writing implement comprises dark colored chalk, for example, but not limited to, black or gray chalk.

In another aspect, a two- or three-dimensional narrative story backdrop is provided that interfaces with the reverse chalkboard cassette and that depicts at least one object, for example, a natural or living object, that may be used to create a story to assist with handwriting instruction and that promotes spatial orientation for handwriting. The reverse chalkboard cassette may be configured to reversibly attach to the backdrop or to fit within a recess in the backdrop. In one non-limiting embodiment, the backdrop depicts a representation of a live tree, for example, with a trunk that extends from the base of the backdrop and leaves and/or branches that extend from the trunk to the top of the backdrop. In some embodiments, accessory items are provided to enhance the story, to assist with handwriting instruction and/or to promote spatial orientation for handwriting. In one non-limiting embodiment, the backdrop depicts a live tree, as described above, and the accessory items may include birds and/or other animals that live in or around the tree, and/or one or more birds' nests.

In another aspect, a plurality of handwriting practice cards is provided. In some embodiments, for example, for instruction and practice of upper case letters and numerals, the cards may include first and second solid lines and a dashed line, in a configuration and color scheme that replicates the lines and writing area on the reverse chalkboard cassette, and may optionally further include thematic elements that correspond to a themed narrative story. In some embodiments, for example, for instruction and practice of lower case letters, the cards may include first and second solid lines and a dashed line, and a second writing area below the second solid line, in a configuration and color scheme that replicates the lines and writing areas on the reverse chalkboard cassette, and may optionally further include thematic elements that correspond to a themed narrative story. The cards may be sized and/or configured to fit within a recessed area of the reverse chalkboard cassette. Optionally, the cards may be used independently of the reverse chalkboard cassette, for example, on a tabletop or other surface. In some embodiments, the cards are smaller or larger than the recessed area of the reverse chalkboard cassette. In some embodiments, cards depict an outline or shaded depiction of a letter or a numeral, such as a letter or numeral that can be traced. In some embodiments, the cards depict a letter or numeral and optionally also include one or more orientation, direction, and/or sequencing indicator(s) to assist the student with starting, direction of, and/or sequencing of writing strokes to form the letter or numeral. In some embodiments, the cards include solid and dashed lines in the same or similar configuration and in the same or similar color scheme as the reverse chalkboard cassette. In some embodiments, the cards include a surface that may be written on and erased.

In some embodiments, cards depict one or more orientation indicators in addition to the lines and writing area(s), as described above, such as one or more dot(s), animal(s), and/or object(s), for example, corresponding to a themed narrative story, for free writing without the depictions of letters or numerals to serve as a guide. For example, cards that contain only an orientation indicator, in addition to lines and writing area(s) may contain the indicator at a top left, top center, or top right position to indicate the starting position of writing strokes to form a letter or numeral. In some embodiments, the cards include sequencing indicators, for example, numbers that indicate the sequence of writing strokes to form the depicted letter or numeral. In some embodiments, cards depict orientation and sequencing indicator(s) without depiction of letters or numerals. In some embodiments, the cards include direction indicators, for example, arrows, and optionally further include sequencing indicators, for example, numbers, to indicate the direction and sequence of writing strokes, respectively.

In some embodiments, a flexible material may be used for placement on top of the depicted numerals or letters on the cards, or for formation of letters or numerals on cards that do not contain depicted letters or numerals (e.g., on cards that contain only an orientation indicator, or orientation and direction and/or sequencing indicator(s)). In some embodiments, the flexible material includes foam, such as, but not limited to, polyurethane or polyethylene foam, with or without additives. In some embodiments, an adhesive material may be used to reversibly adhere the flexible material to the card, for example, double stick tape or another adhesive material.

In another aspect, a bendable material may be provided for use in conjunction with other components of the handwriting instruction methods and systems disclosed herein, and which may be used by a therapist, instructor, or student to form letters or numerals and to reinforce appearance and proper formation of letters and numerals. The bendable material may be sized to be used conjunction with the reverse chalkboard cassette or cards, as described above, or may be sized to used independently of other components, such as the reverse chalkboard cassette, the plurality of practice cards, or instruction and practice writing sheets, but in a manner that reinforces the instructional aspects of the other components.

In another aspect, writing sheets are provided for use in the methods and systems for handwriting instruction described herein. In some embodiments, for example, for instruction and practice of upper case letters and/or numerals, the writing sheet includes one or more writing block that includes a top and a bottom, and further includes a first solid line at the top or substantially at the top of the writing block, and a dashed line, wherein the area between the first and second solid lines provides a first writing area, wherein the dashed line is located at an intermediate position between the first solid line and the second solid line, and wherein the first solid line, the second solid line, and the dashed line are parallel or substantially parallel to each other. In some embodiments, the second solid line is at the bottom or substantially at the bottom of the writing block. In other embodiments, the writing block includes a second writing area below the second solid line and extending to the bottom or substantially to the bottom of the writing block. In some embodiments, the second writing area is a different color or shade than the first writing area.

The writing sheet may include one or a plurality of writing blocks. In some embodiments, the writing block includes an outline of a letter or numeral between the first and second solid lines and superimposed over the dashed line, e.g., upper case letter or numeral. In other embodiments, the writing block includes an outline or shaded depiction of a letter between the first and second solid lines and superimposed over the dashed line, between the dashed line and the second solid line, or starting at the dashed line and extending into the second writing area, e.g., a lower case letter with a portion that extends below the second solid line (i.e., below the line on a standard writing sheet).

In some embodiments, the writing block includes one or more orientation, direction, and/or sequencing indicator(s), in addition to the depicted letter or numeral. In some embodiments, the writing block includes an orientation indicator, e.g., a dot or a thematic element, such as a bird, e.g., in the top left, center, or right of the writing block. Optionally, the writing block is depicted with, depicted within, or superimposed over a pictorial representation of at least one object that may be used to create a story to assist with handwriting instruction and that promotes spatial orientation for handwriting.

Although numerous other color schemes are contemplated, in some embodiments of the writing blocks described herein, the first solid line is green and the second solid line is red. In some embodiments, the dashed line is brown. In some embodiments, the writing sheets are used in conjunction with other handwriting instruction system components as described herein, e.g., reverse chalkboard cassette and/or letter/numeral practice cards, and the color scheme (solid lines, dashed line, writing area(s)) is the same or similar to the other components of the system, providing consistency in visual cues. In some embodiments, a plurality of writing sheets is provided in which writing blocks are successively smaller for practice of letters or numerals that become successively smaller as the student progresses in the handwriting instruction or remediation program.

In another aspect, writing sheets are provided for handwriting instruction and practice. A writing sheet may include pairs of first and second writing areas, in a repeating pattern in a direction from top to bottom of the handwriting sheet, wherein in each pair of first and second writing areas, the first writing area is above the second writing area. Each first writing area includes, in a direction from top to bottom, a first solid line at the top of the first writing area, a dashed line, and a second solid line at the bottom of the first writing area, wherein the dashed line is at a position that is intermediate between the first and second solid lines. The first solid lines, second solid lines, and dashed lines of the first writing areas are printed on the sheet and are parallel or substantially parallel to each other. In some embodiments, the first solid lines, second solid lines, and dashed lines may extend all the way to the edges or substantially to the edges of the writing sheet. In other embodiments, the first solid lines, second solid lines, and dashed lines do not extend all the way to the edges of the writing sheet. In some embodiments, the first solid line is a different color than the second solid line. In some embodiments, the second solid line is raised from the surface of the paper. In some embodiments, the second writing area is a different color or shade than the first writing area. Although numerous color combinations are possible and are contemplated within the scope of the invention, in one embodiment, the first solid line is green and the second solid line is red. In some embodiments, the dashed line is a different color than the first and second solid line. Although numerous colors are possible and are contemplated within the scope of the invention, in one embodiment, the dashed line is brown. In one embodiment, the first solid line is green, the second solid line is red, and the dashed line is brown. In some embodiments, the second writing area is a darker color or shade than the first writing area, for example, darker than the first writing area by a Munsell value of about 2 to about 5, or at least about 2, or at least about 3, at least about 4, or at least about 5.

In some embodiments of the writing sheets, at least one letter or numeral is depicted (e.g., as a solid depiction, an outline, or a shaded depiction) in at least one writing area. In other embodiments, the writing sheet contains only first and second writing areas without depicted letter(s) or numeral(s). In one embodiment, an upper case letter or numeral is depicted in at least one first writing area. In one embodiment, at least a portion of a lower case letter is depicted in at least one first writing area. In one embodiment, a portion of a lower case letter is depicted in at least one second writing area (i.e., a portion of a lower case letter that extends below the line on standard writing sheets). In some embodiments, the writing sheet includes one or more orientation, direction, and/or sequencing indicator(s) in at least one first or second writing area.

### BRIEF DESCRIPTION OF THE DRAWINGS

FIGS. 1A-1D show an embodiment of a reverse chalkboard cassette, configured for instruction and practice of upper case letters and numerals. FIGS. 1A and 1B show the front side of the reverse chalkboard cassette with a writing surface surrounded by a frame configured for insertion of cards. FIG. 1C shows the back side of the reverse chalkboard cassette. FIG. 1D shows a side view of the reverse chalkboard cassette.

FIGS. 2A-2D show an embodiment of a reverse chalkboard cassette, configured for instruction and practice of lower case letters. FIGS. 2A and 2B show the front side of the reverse chalkboard cassette with a writing surface surrounded by a frame configured for insertion of cards. FIG. 2C shows the back side of the reverse chalkboard cassette. FIG. 2D shows a side view of the reverse chalkboard cassette.

FIGS. 3A-3C show an embodiment of a thematic backdrop for handwriting instruction in conjunction with the reverse chalkboard cassette, configured as a tree. FIG. 3A shows an embodiment of openings in the backdrop for reversible insertion of compatible hardware on the back of the reverse chalkboard cassette. FIG. 3B shows an embodiment of the backdrop with an inserted reverse chalkboard cassette that is configured for instruction and practice of upper case letters and numerals. FIG. 3C shows an embodiment of the backdrop with an inserted reverse chalkboard cassette that is configured for instruction and practice of lower case letters.

FIGS. 4A-4F show embodiments of hardware for mounting a reverse chalkboard cassette to a thematic backdrop. FIG. 4A shows a side view of an embodiment of a reverse chalkboard cassette, configured for instruction and practice of upper case letters and numerals, mounted to a backdrop with mounting pins on the reverse chalkboard cassette inserted into partially drilled holes on the backdrop. FIG. 4B shows a side view of an embodiment of a reverse chalkboard cassette, configured for instruction and practice of upper case letters and numerals, mounted to a backdrop with bolts that insert through the backdrop. FIG. 4C shows an embodiment of a side view of a reverse chalkboard cassette, configured for instruction and practice of lower case letters, mounted to a backdrop with mounting pins on the reverse chalkboard cassette inserted into partially drilled holes on the backdrop. FIG. 4D shows an embodiment of a side view of a reverse chalkboard cassette, configured for instruction and practice of lower case letters, mounted to a backdrop with bolts that insert through the backdrop. FIG. 4E shows bolts on the back of the backdrop for mounting an embodiment of a reverse chalkboard cassette that is configured for instruction and practice of upper case letters and numerals. FIG. 4F shows bolts on the back of the backdrop for mounting an embodiment of a reverse chalkboard cassette that is configured for instruction and practice of lower case letters.

FIG. 5 shows an embodiment of a flexible material formed in the shape of a letter as depicted on letter formation guide.

FIGS. 6A-6C show an embodiment of an upper case letter practice card inserted into the recessed area of a reverse chalkboard cassette that is mounted to a narrative backdrop. FIG. 6A depicts an embodiment of a practice card. FIG. 6B depicts an embodiment of flexible material placed over the letter on the practice card. FIG. 6C depicts an embodiment in which character chips that are thematically related to the narrative backdrop are included.

FIGS. 7A-7B show embodiments of writing sheets for instruction and practice of a depicted upper case letter. FIG. 7A shows an embodiment of a writing sheet that depicts the reverse chalkboard cassette and a practice card for a depicted upper case letter. FIG. 7B shows en embodiment of a writing sheet that includes writing blocks with and without a shaded depiction of the letter to be practiced.

FIG. 8 shows an embodiment of a writing sheet for instruction and practice of a depicted upper case letter.

FIG. 9 shows an embodiment of a writing sheet for instruction and practice of a depicted upper case letter.

FIGS. 10A-10C show embodiments of a writing sheet or card for freehand upper case letter or numeral instruction and practice, using a left (FIG. 10A), right (FIG. 10B), or center (FIG. 10C) thematic story element, depicted as a bird, as an orientation marker for the beginning stroke of the letter or numeral.

FIGS. 11A-11C show embodiments of writing sheets or cards for freehand upper case letter or numeral instruction and practice, as a plurality of writing sheets or cards in tear-off pads. FIG. 11A depicts writing sheets or cards with an upper right orientation indicator. FIG. 11B depicts writing sheets or cards with an upper middle orientation indicator. FIG. 11C depicts writing sheets or cards with an upper left orientation indicator.

FIGS. 12A-12C show embodiments of a writing sheet or card for freehand upper case letter or numeral instruction and practice, using a left (FIG. 12A), right (FIG. 12B), or center (FIG. 12C) dot as an orientation marker for the beginning stroke of the letter or numeral.

FIGS. 13A-13C show embodiments of writing sheets or cards for freehand upper case letter or numeral instruction and practice, as a plurality of writing sheets or cards in tear-off pads. FIG. 13A depicts writing sheets or cards with an upper right orientation indicator. FIG. 13B depicts writing sheets or cards with an upper middle orientation indicator. FIG. 13C depicts writing sheets or cards with an upper left orientation indicator.

FIG. 14 shows an embodiment of a writing sheet for instruction and practice of upper case letters or numerals, with two writing blocks on the sheet having an upper left orientation indicator.

FIG. 15 shows an embodiment of a writing sheet for instruction and practice of upper case letters or numerals, with two writing blocks on the sheet having an upper middle orientation indicator.

FIG. 16 shows an embodiment of a writing sheet for instruction and practice of upper case letters or numerals, with two writing blocks on the sheet having an upper right orientation indicator.

FIG. 17 shows an embodiment of a writing sheet for instruction and practice of upper case letters or numerals, with two writing blocks on the sheet having an upper left orientation indicator, as a plurality of writing sheets in tear-off pads.

FIG. 18 shows an embodiment of a writing sheet for instruction and practice of upper case letters or numerals, with ten writing blocks on the sheet having an upper left orientation indicator.

FIG. 19 shows an embodiment of a writing sheet for instruction and practice of upper case letters or numerals, with ten writing blocks on the sheet having an upper left orientation indicator, as a plurality of writing sheets in a tear-off pad.

FIG. 20 shows an embodiment of a writing sheet that includes a plurality of writing blocks, some of which are different (different upper case letters) and some of which are the same (three different pluralities of writing blocks with upper left, middle, or right orientation indicators.

FIG. 21 shows an embodiment of a writing sheet that includes a plurality of writing blocks, some of which are different (depicting different upper case letters) and some of which are the same (three different pluralities of writing blocks with upper left, middle, or right orientation indicators, as a plurality of writing sheets in a tear-off pad.

FIG. 22 shows an embodiment of a lower case letter practice card inserted into the recessed area of a reverse chalkboard cassette that is mounted to a narrative backdrop.

FIG. 23 shows an embodiment of a writing sheet for instruction and practice of a depicted lower case letter.

FIG. 24 shows an embodiment of a writing sheet for instruction and practice of a depicted lower case letter.

FIG. 25 shows an embodiment of a writing sheet for instruction and practice of a depicted lower case letter.

FIG. 26 shows an embodiment of a writing sheet for instruction and practice of a depicted lower case letter.

FIG. 27 shows an embodiment of a writing sheet for instruction and practice of a depicted lower case letter.

FIG. 28 shows an embodiment of a writing sheet for instruction and practice of a depicted lower case letter.

FIGS. 29A-29B show an embodiment of a writing sheet. FIG. 29A shows a top view of the writing sheet. FIG. 29B shows a side view of the writing sheet.

### DETAILED DESCRIPTION

The systems and methods described herein provide a spatially oriented, multi-sensory handwriting instruction program. The handwriting instruction program described herein maintains consistent instructional cues and relative coloring of the writing versus the background (dark writing strokes on a lighter writing surface). This design promotes continuity across all of the learning surfaces of the program, which is integral for blocked practice. The program described herein incorporates consistent spatial orientation for blocked practice, enhances pinch and grip strength, and promotes multisensory learning. Embodiments provide a social story engagement for joint attention and a quiet chalk writing system that is consistent in lines and coloration across multiple practice and mediums. In some embodiments, letters may be taught from easiest to hardest. For example, the Beery-Buktenica Developmental Test of Visual-Motor Integration may be used as a guide. In some embodiments, specific letters may be taught or practiced that a particular student is having difficulty with.

The program may include a “reverse chalkboard cassette,” which allows a student to make dark colored writing strokes on a light colored surface, to promote an easier transition to pencil or pen on writing paper than a traditional dark colored chalkboard with light colored chalk. Further, use of small pieces of chalk on such a reverse chalkboard cassette promotes proper pencil motor control and correct pencil grip. In addition, the surface properties of the reverse chalkboard cassette provide proprioceptive input to the hand, which contributes a multi-sensory component to enhance handwriting instruction and remediation.

Many current handwriting instruction techniques employ the use of dry erase boards, along with dry erase markers. A dry erase writing surface is very smooth, and writing with a dry erase marker on such a surface is very quick. Effective access is not provided for students who are primary kinesthetic/proprioceptive or auditory learners. Research has shown that the way humans learn can be very different. The lack of input restricts learning to one pathway (visual), which does not access alternate pathways for a student who has primary learning styles other than visual. The multiple approaches and access points within the systems and methods disclosed herein mirrors the accepted paradigm of “universal design for learning,” which creates a solid learning platform for all students through 1) varied representation of content and concepts, 2) multiple means of action and expression, and 3) providing multiple means to encourage engagement.

The program may also include visuals and manipulatives to create an engaging story narrative to appeal to the student and help maintain focus. This approach provides a consistent framework for correct placement of letters and numerals, and helps the student engage with the material and remember the correct way to form letters and numerals.

This program caters to the specific sensory and other needs experienced frequently by the ASD student, students with intellectual disabilities, and students who display difficulties with visual-perceptual requirements and/or underlying sensory motor components. In addition, it has been designed to be effective and highly engaging for normally developing students, and is particularly useful for remediation of handwriting issues for all students. The inclusion of an interrelated set of learning and practice materials that are consistent in terms of teaching elements and appearance allow the therapist, teacher, or other trainer to begin using the program at any point required by the skill level of the student.

The handwriting instruction program is designed so that students may receive decreasing levels of guidance as they progress. The system is highly flexible in that the student can drop into the system at any point. There is a component that will be appropriate for any skill level as a starting point. Then, the student can progress along the path of the system. This is particularly important to provide a key advantage for handwriting remediation instruction. In addition, students who display difficulty creating a particular letter, group of letters, or a have a specific skill issue (e.g., students who fail to start lower case letters at the appropriate place) can move “backwards” in the system for that particular letter or group of letters until the skill is developed. The student may then progress through the remainder of the steps or may need no further systemic intervention.

Integrated handwriting instruction and/or remediation systems are provided. There is consistent coloring, style, visual cues, guides, spatial orientation, line construction, etc. throughout the program, allowing it to work seamlessly to progress students through the system and providing flexibility such that students may start at any point in the path, depending on their individual needs. This is true even between different physical material types (e.g., chalkboard, practice cards (e.g., laminated cards), practice sheets (e.g., paper workbook pages), final writing paper, bendable material). Each component is included in the program for a particular reason. For example, the raised lower line on the final writing paper provides a “stop” that the student feels. Also, the shaded area of the writing paper provides an important region to help the student understand that “nothing” goes there except in the special case of portions of lower case letters that extend below the lower line. The system is integrated and may include a narrative social story, which has been shown to be effective in triggering learning of handwriting. The narrative may provide spatial reference points for integration of spatial recognition and orientation with handwriting learning or remediation. It is an integrated approach using techniques designed for consistent learning (e.g., tracing, consistency in the dark colored writing strokes to alleviate confusion in the transition to traditional pencil and paper). In some embodiments of the methods and systems described herein, materials are designed to assist the student in progressing from larger to smaller letter or numeral formation. For example, writing practice sheets that contain progressively smaller writing blocks that include the same or similar lines, colors, visual cues, etc. may be provided to assist the student in progressing to smaller letter or numeral formation while remaining within the visual framework provided by other materials in the system.

The methods and systems described herein are suitable for instruction and/or remediation for handwriting printed upper case letters, printed lower case letters, and/or numerals. The methods and systems herein may be adapted for lettering systems of different languages, such as, but not limited to, printed Latin/Roman, Cyrillic, Greek, or Hebrew letters, i.e., the methods and systems herein are language neutral.

### Reverse Chalkboard Cassette

A “reverse chalkboard cassette” may be used to provide proprioceptive feedback and boundaries. The reverse chalkboard cassette provides a surface for handwriting instruction and practice and also provides a recessed area into which cards may be inserted as templates for individual letter or numeral instruction and practice. Solid upper and lower lines provide top (upper line) and bottom (lower line) boundaries for upper case letters (e.g., upper case printed letters) and numerals and for some lower case letters (e.g., lower case printed letters), and a dashed line between the solid lines provides a reference to the center of the letter or numeral or a starting point for some lower case letters. The upper and lower solid lines and dashed line may be any color or combination of colors, and may optionally be designed to interface with a thematic backdrop or narrative story. One non-limiting embodiment includes a green upper line (e.g., “green means GO”) and a red lower line (e.g., “red means STOP”). In one embodiment, the dashed line is brown. In some embodiments, the writing surface may include an orientation or direction indicator, such as a dot, an arrow, and/or a representation of an animal or object that is designed to interface with a thematic backdrop or narrative story.

The writing surface of the reverse chalkboard cassette forms a recessed area, at least a portion of which is surrounded by a raised area or frame that guides and limits letter or numeral size. In some embodiments, raised upper and/or lower lines may be included on the writing surface to provide a physical boundary for starting and/or stopping points for handwriting strokes. A dashed line may be included, between the upper and lower lines, to provide a reference to the center of the upper case letters or numerals, or the starting point for some lower case letters, and may optionally be raised from the surface.

Optionally, the upper and/or lower solid line(s) may be raised from the surface of the of the reverse chalkboard cassette, providing a tactile starting and/or stopping point for letter or numeral formation. For example, plastic inserts may be added on top of the upper and/or lower solid line(s). In one embodiment, a cylindrical plastic rod may be used to accentuate the line. For example, the raised material may be made from colored 3-D printing ink, e.g., acrylonitrile butadiene styrene (ABS) or polyacetic acid (PLA), or from extruded plastic material. The raised material is typically cylindrical, although other geometries may be used (e.g., square, rectangular, etc.). In some embodiments, the raised line(s) are constructed of wood, for example, cylindrical, square, or rectangular wood rods. The raised line(s) may be attached to the reverse chalkboard cassette surface using an adhesive. The ends of the raised line(s) may or may not be inserted into a frame that surrounds the writing surface. In a non-limiting embodiment, the reverse chalkboard cassette includes a green raised upper line and a red raised lower line.

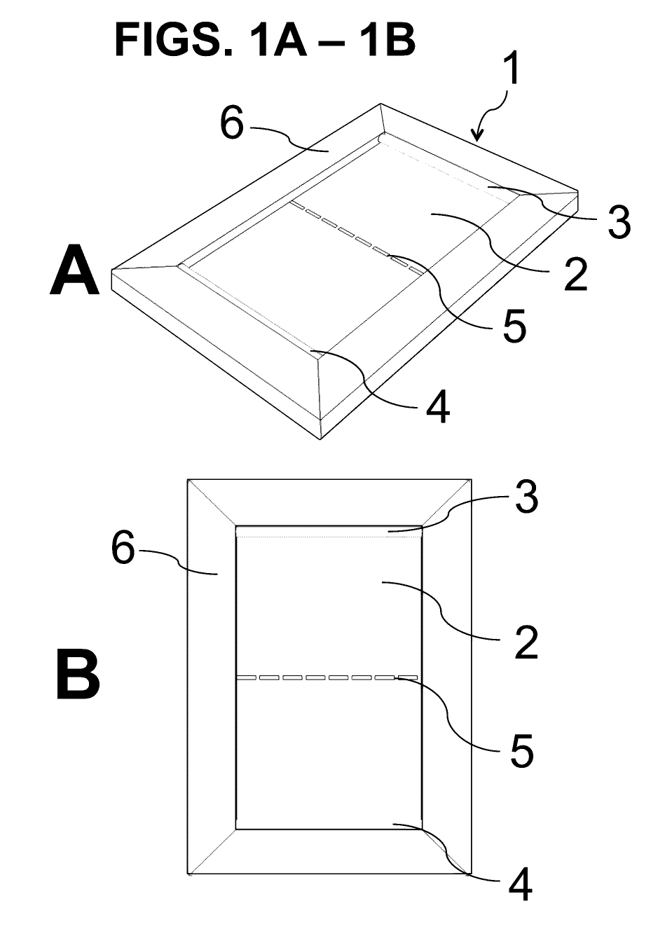

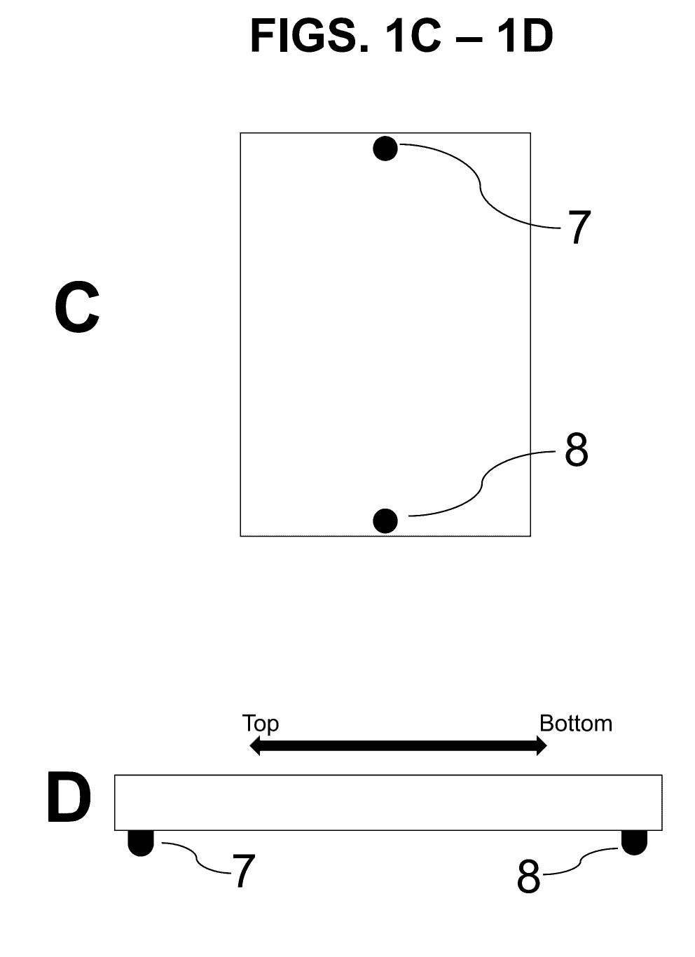

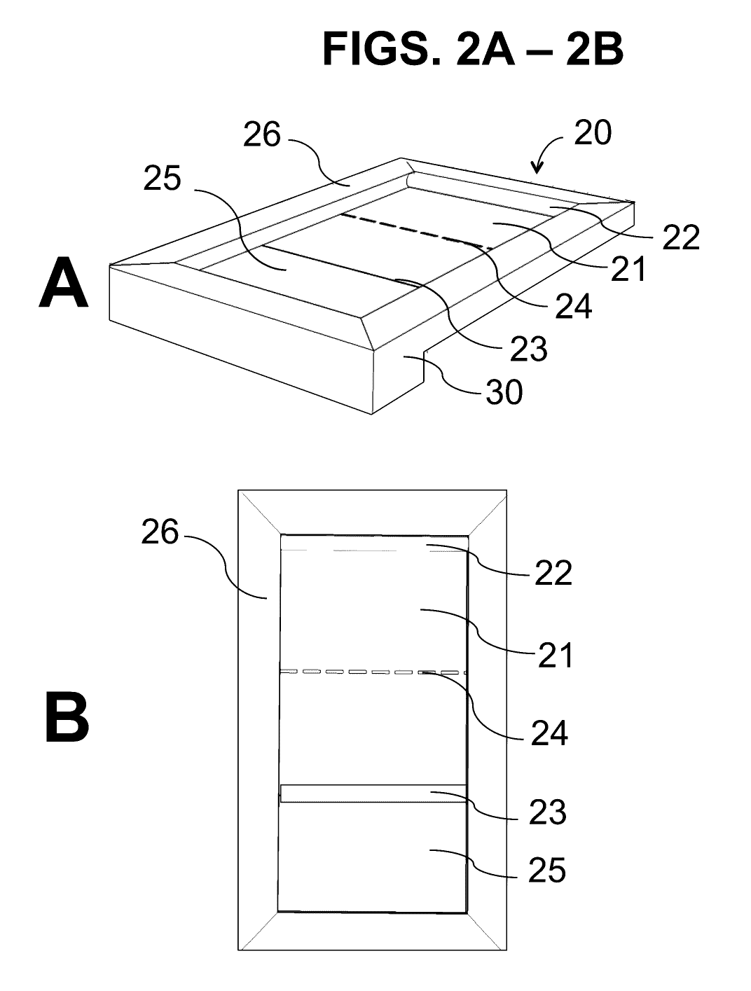

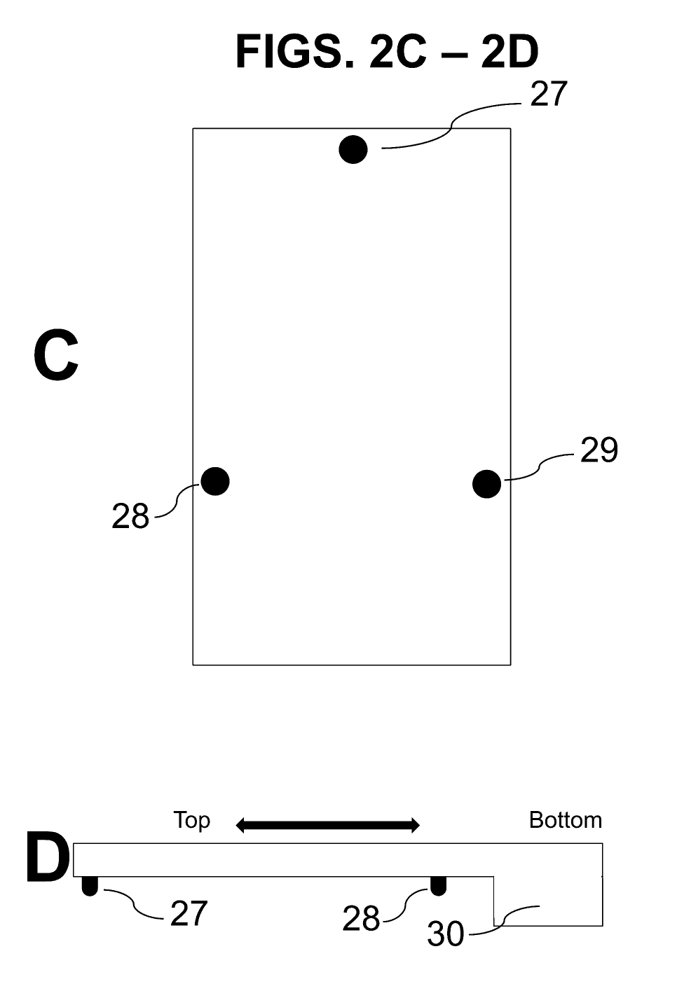

In some embodiments, the writing surface includes a writing area bounded by a first solid line at the top or substantially at the top of the writing surface, a second solid line, and a dashed line between the first and second solid lines. In one embodiment, shown in FIGS. 1A and 1B, the reverse chalkboard cassette 1 includes a writing area 2, which is defined by a first solid line 3 at the top of the writing area and a second solid line 4 at the bottom of the writing area. The writing area includes a dashed line 5 between the first and second solid lines. In one embodiment, the dashed line is approximately half the distance between the first and second solid lines. The embodiment of the reverse chalkboard cassette depicted in FIGS. 1A-1D may be used for instruction and practice of upper case letters, numerals, and some lower case letters that do not have portions that extend below the line on writing paper, e.g., below the second solid line 4 as depicted in FIGS. 1A and 1B. In one embodiment, the reverse chalkboard cassette depicted in FIGS. 1A-1D is used for instruction and practice of upper case letters and numerals, and a second reverse chalkboard cassette, as described below, one embodiment of which is depicted in FIGS. 2A-2D, is used for instruction and practice of lower case letters. In the embodiment depicted in FIGS. 1A and 1B, the writing area 2 is in a recessed area surrounded by a frame 6.

In some embodiments, the writing surface further includes a second writing area below the second solid line and extending to the bottom or substantially to the bottom of the writing surface. In one embodiment, shown in FIGS. 2A and 2B, the reverse the reverse chalkboard cassette 20 includes a first writing area 21, which is defined by a first solid line 22 at the top of the writing area and a second solid line 23 at the bottom of the first writing area. The first writing area includes a dashed line 24 between the first and second solid lines. In one embodiment, the dashed line is approximately half the distance between the first and second solid lines. A second writing area 25 extends below the second solid line to the bottom or substantially to the bottom of the writing surface. In some embodiments, the second writing area 25 may be shaded a different or darker color than the first writing area 21. For example, in some non-limiting embodiments, the second writing area may be darker than the first writing area by a Munsell value of about 2 to about 4, or at least about 2, at least about 3, or at least about 4. The embodiment of the reverse chalkboard cassette depicted in FIGS. 2A-2D may be used for instruction and practice of upper case letters, numerals, and lower case letters, including lower case letters that have portions that extend below the line on writing paper, e.g., below the second lower line as depicted in FIGS. 2A and 2B. In one embodiment, the reverse chalkboard depicted in FIGS. 2A-2D is used for instruction and practice of lower case letters. In the embodiment depicted in FIGS. 2A and 2B, the first and second writing surfaces are in a recessed area surrounded by a frame 26.

The writing surface(s) may be constructed of any material that provides appropriate proprioceptive feedback through the hand of the student when writing on the surface with a writing implement, for example, chalk, which may be easily erased (e.g., erasure of chalk) for re-use. The proprioceptive input to the hand contributes a multi-sensory component, which has been documented in studies to enhance handwriting instruction and/or remediation. To provide proprioceptive feedback, the surface of the chalkboard must provide resistance to the writing implement, e.g., chalk, while writing. Although not wishing to be bound by theory, this resistance may be transmitted through the hand via neural pathways to the brain, which locks in the motor pathway of formation of the letter or numeral (motor engram). Surfaces that are too smooth or glossy will not provide an adequate amount of input to the hand and will not accept writing with an implement such as chalk well. A surface that is too matte will give input but may not erase for re-use. A surface that provides a balance between providing proprioceptive feedback to the hand when writing and erasability is desirable.

In one embodiment, a laminate material is used, such as a high pressure decorative laminate according to the European Standard EN 438 and to ISO 4586, for example, a Formica® laminate. In a non-limiting embodiment, a laminate is used that includes layers of cellulose fibrous material (e.g., paper) impregnated with thermosetting resins and bonded together in a high-pressure process. The process, which includes simultaneous application of heat (≧120° C.) and high specific pressure (≧5 MPa), provides flowing and subsequent curing of the thermosetting resins to obtain a homogeneous non-porous material (≧1,35 g/cm³) with the required surface finish. In some embodiments, more than 60% of the laminate material includes paper and the remaining 30 to 40% includes cured phenol-formaldehyde resin for core layers and melamine-formaldehyde resin for the surface layer. Both resins are thermosetting resins that are irreversibly reacted through cross-linked chemical bonds formed during the curing process, producing a non-reactive, stable material with characteristics that are different from those of its component parts.

In other embodiments, the writing surface includes a painted surface or a printed sticker with a clear coating, for example, but not limited to, clear chalkboard paint, epoxy, lacquer, polyurethane, varnish, and/or other clear or protective finish.

In some embodiments, at least a portion of the writing surface of the reverse chalkboard cassette, at least a portion of a substructure beneath the writing surface, and/or at least a portion a raised area or frame that surrounds the writing surface may include a magnetic or magnetic receptive material. In some embodiments, narrative story characters and/or other objects may include a magnetic or magnetic receptive material, for example, on a rearward-facing surface of the character or object, that is magnetically attracted to the magnetic or magnetic receptive material in the reverse chalkboard cassette, for enhancement of instruction using a thematic narrative story as described herein.

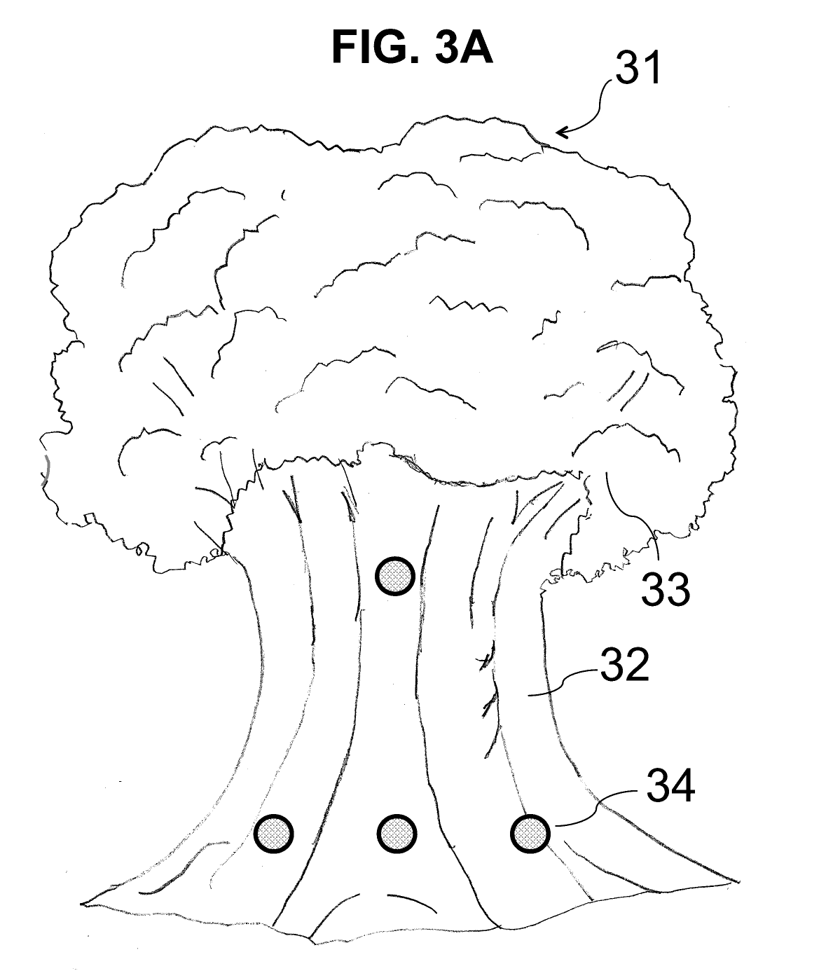

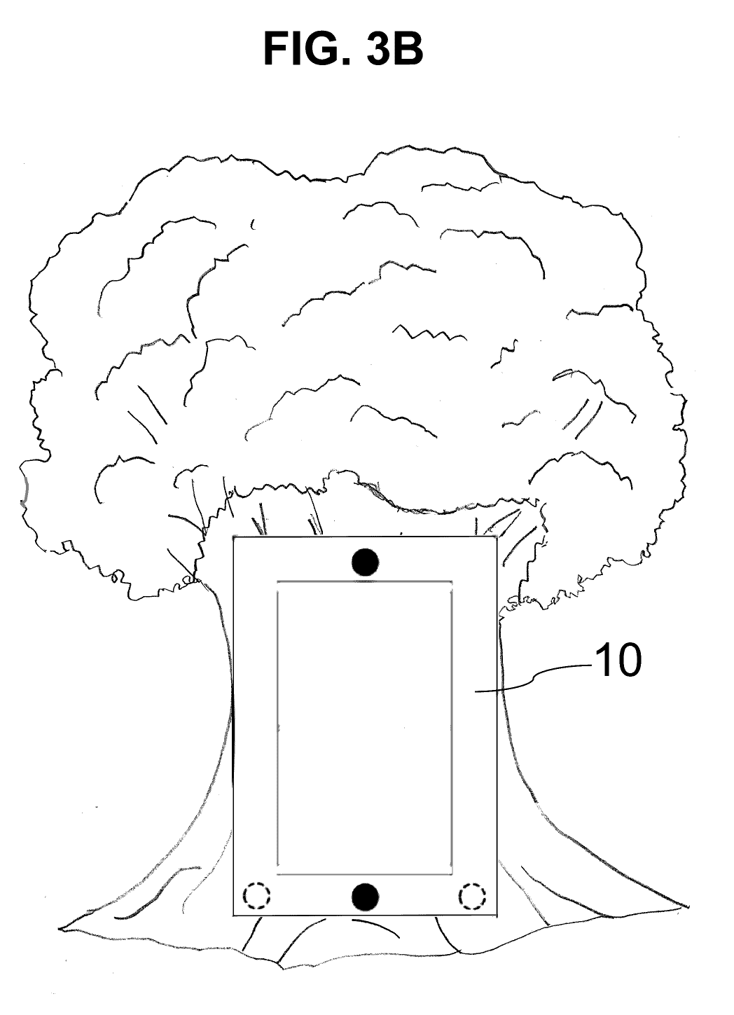

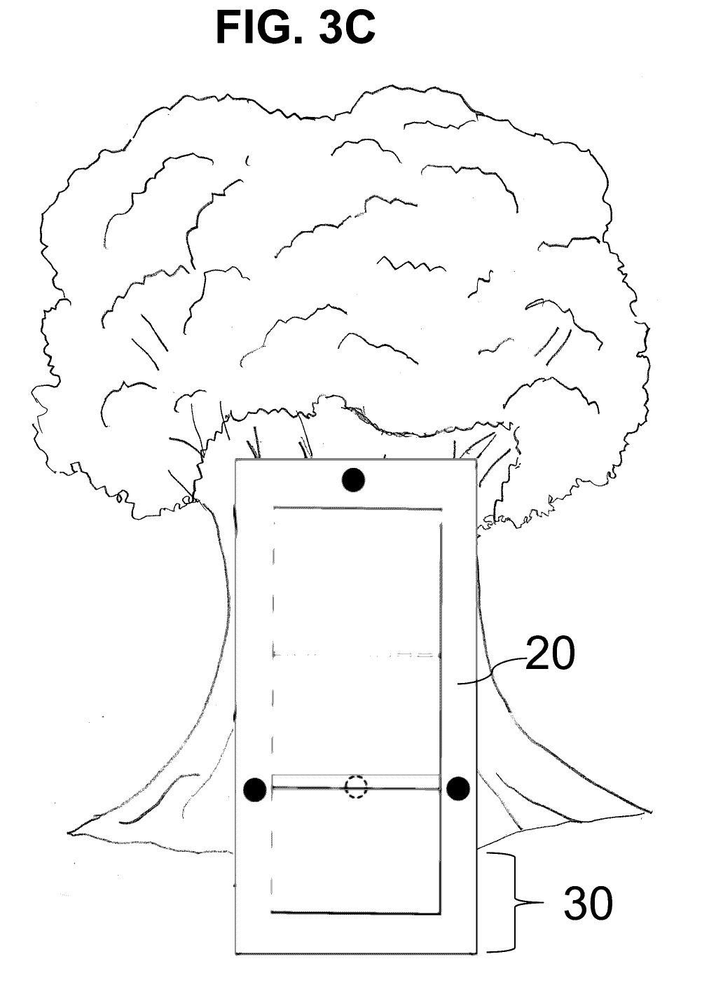

The back of the reverse chalkboard cassette (i.e., the face that is opposite the writing surface) may optionally include hardware or fasteners to reversibly mount or attach the reverse chalkboard cassette to a narrative story backdrop. One embodiment, which includes two pins 7 and 8 on the back of the reverse chalkboard cassette that fit into holes on the front of the backdrop, is shown in FIGS. 1C and 1D. In some embodiments, the pins include caps constructed of a material that is soft to the touch, for example, rubber or plastic, and which may prevent marring of surfaces that the chalkboard may rest on when not engaged with the backdrop. Caps may also provide a snug fit between the reverse chalkboard cassette and the backdrop, and prevent movement or rattling of the chalkboard when in use. In an alternate embodiment, the front of the backdrop may include pins that fit into holes on the back of the reverse chalkboard cassette. An embodiment of a narrative story backdrop configured for attachment of a reverse chalkboard cassette as described herein, is depicted in FIG. 3A. An embodiment of the reverse chalkboard cassette depicted in FIGS. 1A-1D, reversibly attached to a narrative story backdrop, is shown in FIG. 3B. Another embodiment, which includes three pins 27, 28, and 29 that fit into holes in the backdrop is shown in FIG. 2C, optionally with section 30 as shown in FIG. 2D. Section 30 optionally allows the base of the reverse chalkboard cassette to extend below the base of the backdrop. Section 30 provides support to prevent tipping of the apparatus when the student puts pressure from their hand and arm on the bottom of the reverse chalkboard cassette to write. Section 30 may be the same thickness as the backdrop so that it supports the chalkboard and allows the bottom of the reverse chalkboard cassette to rest on a table or other surface as does the backdrop. An embodiment of the reverse chalkboard cassette depicted in FIGS. 2A-2D, reversibly attached to a narrative story backdrop, is shown in FIG. 3C.

### Writing Implement for Reverse Chalkboard Cassette

A dark colored chalk or other writing implement that produces a dark colored writing stroke on the lighter colored writing surface of the reverse chalkboard cassette is used, which assists with transitioning the student to traditional pencil or pen on writing paper, i.e., pencil or pen that produces darker colored writing strokes on lighter colored writing paper. The chalkboard surface and writing implement are selected to give critical proprioceptive input to the hand of the student, as described above. For example, the writing implement may be chalk, artist pastels, or dry erase crayons. In some embodiments, use of small pieces of chalk or other writing implement may promote proper pencil motor control and correct pencil grip.

In some embodiments, the writing produced by the writing implement may be erased with an eraser, such as a dry erase eraser. An eraser such as a dry erase eraser may optionally be included in the handwriting instruction and/or remediation systems described herein. In one embodiment, the writing implement includes an eraser on the non-writing end, such as a dry erase eraser. This would allow the student to “flip” the writing implement between writing and erasing configurations, enhancing motor control for eventual transition to use of a pencil or pen.

Although numerous color combinations may be used, in some embodiments, the first writing area, between the upper and lower solid lines, is a white, off-white, or cream color, and the writing implement produces a black or gray writing stroke that may be clearly seen on the lighter colored writing surface. For example, the writing implement may produce a writing stroke that is darker in color than the first writing area by a Munsell value of 2 to about 8, about 2 to about 4, or about 4 to about 8, or a difference of at least about 2, at least about 3, or at least about 4, at least about 5, at least about 6, at least about 7, or at least about 8. In some embodiments, the second writing area, if present, below the second solid line, is a gray color, and the writing implement produces a black or gray writing stroke that is darker in color than the color of the second writing area (e.g., darker by a Munsell value of about 2 to about 4, or at least about 2, at least about 3, or at least about 4) and that may be clearly seen on the darker colored writing surface.

### Narrative Story and Backdrop

A two- or three-dimensional narrative story backdrop may be provided, into which the reverse chalkboard cassette may be reversibly attached, and a story may be created, optionally with accessory items that are thematically paired with the backdrop and used to assist with instruction of letter or numeral formation by the student. The backdrop may be constructed of any material that is capable of support or attachment to the reverse chalkboard cassette. For example, the backdrop may be constructed of a variety of materials, such as, but not limited to, wood, laminate material, plastic, cardboard, particle board, and resin-based material, or other materials that are suitable for the purpose of supporting and attaching the reverse chalkboard cassette, and manipulation and re-use by a therapist, instructor, and/or student. In one embodiment, the backdrop is constructed as a shaped, planar object, but other configurations are possible, and may be inspired by the nature of the particular narrative story designed for use in conjunction with the methods and systems described herein. In some embodiments, the backdrop may be in the form of a natural object, such as a tree.

As one non-limiting example, the backdrop may be in the form of a live tree (e.g., FIG. 3A, 31), with a trunk 32 and leaves 33, and accessory items may include a bird oriented to the top of the tree, e.g., “a bluebird that lives in the leafy green area at the top of the tree,” a bird or animal oriented to the middle of the tree, e.g., an owl that “plays fiddle in the middle,” and a ground dwelling animal, e.g., a groundhog, that “lives at the bottom of the tree near the roots and sometimes tunnels underground.” Such characters can be used to create a narrative story that may be used to orient the student to the starting and/or stopping location, and/or direction, of writing strokes. Colors and/or characters of the narrative and/or backdrop may provide a spatial framework for learning where to start, stop, and/or construct letters or numerals, or portions of letters or numerals. For example, the therapist or instructor may use the bluebird to recite, “fly down to get a worm,” for formation of a vertical line starting at the upper line and progressing to the lower line on the template. For example, the solid upper line is “up top in the leaves where the bluebird lives” (e.g., in the case of a green solid upper line, “green means GO”), and the red line is “down near the roots where the groundhog lives” (e.g., in the case of a red solid lower line, “red means STOP”). As another example, lower-case letters with portions that extend below the lower solid line on the writing template may be designated “groundhoggers” in conjunction with the groundhog character in the themed backdrop and narrative story. The backdrop may optionally include holes 34 configured for reversible attachment to pins on the back of the reverse chalkboard cassette. An embodiment with the reverse chalkboard cassette 10 depicted in FIGS. 1A-1D attached to the backdrop via pins 7 and 8 is depicted in FIG. 3B. An embodiment with the reverse chalkboard cassette 20 depicted in FIGS. 2A-2D attached to the backdrop via pins 27, 28, and 29, and with section 30 extending below the bottom of the backdrop is depicted in FIG. 3C.

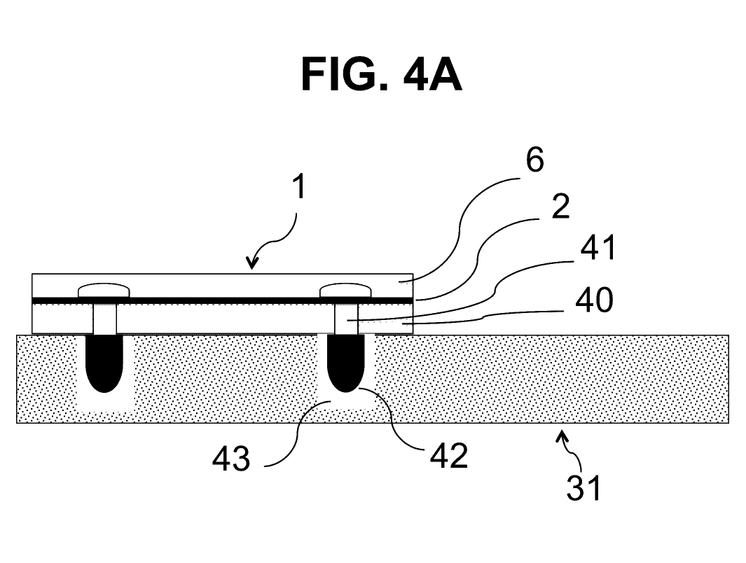

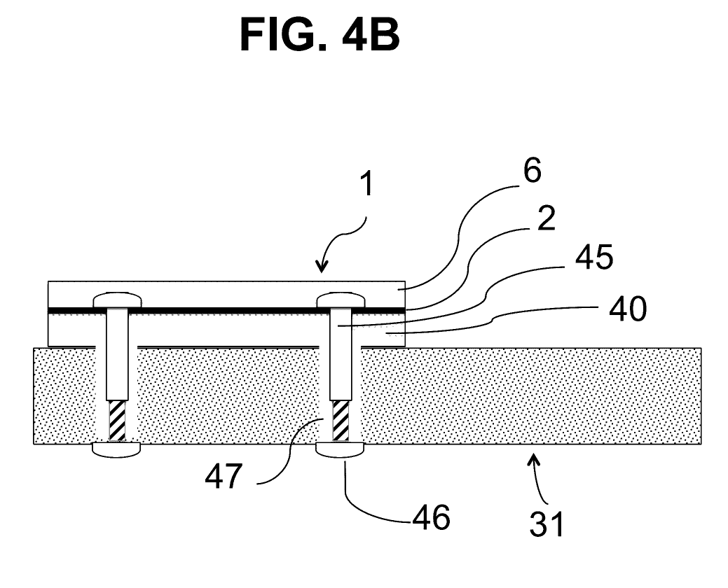

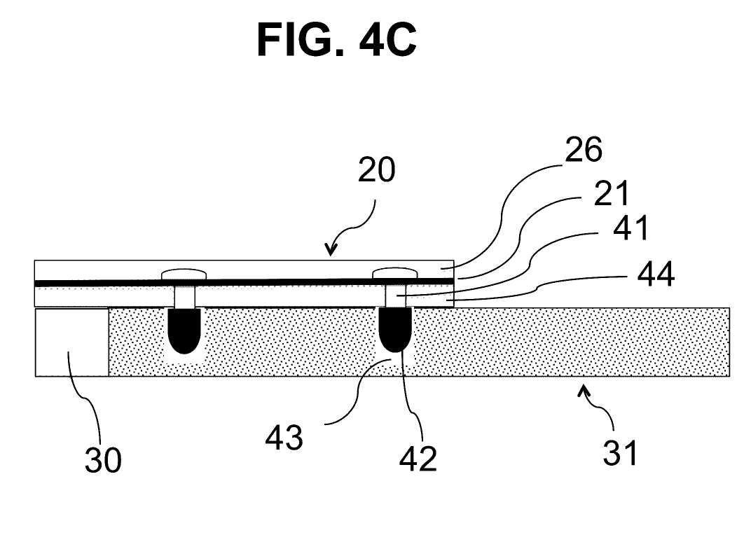

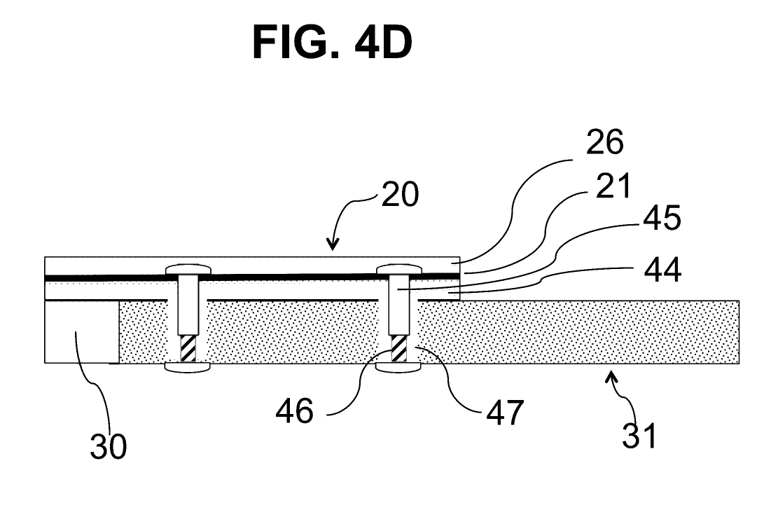

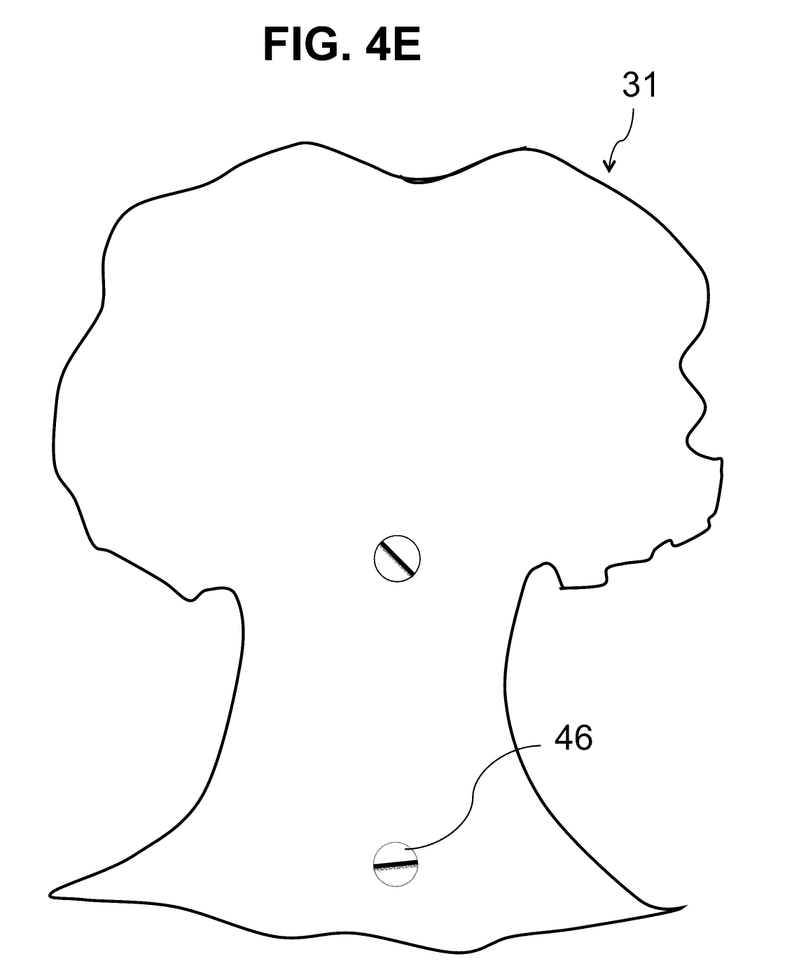

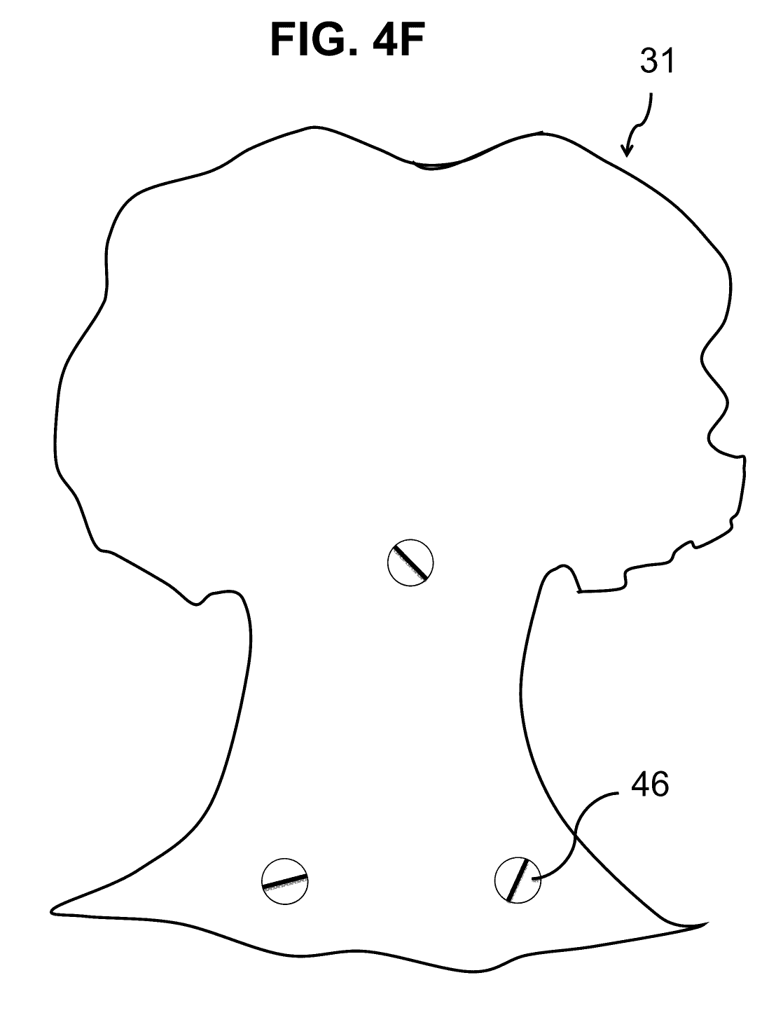

In some embodiments, depicted in FIGS. 4A and 4C, pins on the back of the reverse chalkboard cassette are inserted into partially drilled holes in the backdrop. In the embodiment depicted in FIG. 4A, mounting pins 41 extend through reverse chalkboard cassette 1, from the frame 6 through the writing surface material 2, and through a backing material or substructure 40 beneath the writing surface 2, and into partially drilled holes 43 in the thematic backdrop 31. In some embodiments, caps 42 made of rubber, plastic, or similar material are placed over the ends of pins 41 to provide a snug fit in the drilled holes 43. In the embodiment depicted in FIG. 4C, mounting pins 41 extend through reverse chalkboard cassette 20, from the frame 26 through the writing surface material 21, and through a backdrop material or substructure 44 beneath the writing surface 21, and into partially drilled holes 43 in the thematic backdrop 31. In some embodiments, caps 42 made of rubber, plastic, or similar material are placed over the ends of pins 41 to provide a snug fit in the drilled holes 43.

In some embodiments, depicted in FIGS. 4B and 4D, holes may be drilled all the way through the backdrop, which provides the ability to attach the reverse chalkboard cassette to the backdrop more firmly, optionally permitting writing to be accomplished at an elevated angle rather than in a horizontal orientation. An elevated angle may be accomplished, for example, by placing the backdrop, with reverse chalkboard cassette attached, on an easel or the like. In the embodiment depicted in FIG. 4B, mounting pins or bolts 45 (e.g., barrel nuts, barrel bolts, sex bolts, Chicago screws, postal screws, binding posts) extend through reverse chalkboard cassette 1, from the frame 6 through the writing surface material 2, and through a backing material or substructure 40 beneath the writing surface 2, and into fully drilled holes 47 in the thematic backdrop 31. Bolts 46 insert and tighten into pins 45, fastening the reverse chalkboard cassette to the backdrop. In the embodiment depicted in FIG. 4D, mounting pins 45 extend through reverse chalkboard cassette 20, from the frame 26 through the writing surface material 21, and through a backing material or substructure 44 beneath the writing surface 21, and into fully drilled holes 47 in the thematic backdrop 31. Bolts 46 insert and tighten into pins 45, fastening the reverse chalkboard cassette to the backdrop. FIGS. 4E and 4F show the heads of bolts 46 for fastening reverse chalkboard cassettes to the backdrop 31, for embodiments depicted in FIGS. 4B and 4D, respectively. In some embodiments, the bolt heads may be countersunk into the rear surface of the backdrop in order to produce a flat rear surface of the assembly, which creates a stable interface with potential interacting surfaces.

In some embodiments, at least a portion of the surface of the narrative story backdrop, or at least a portion of a substructure beneath the surface of the narrative story backdrop, may include a magnetic or magnetic receptive material. In some embodiments, narrative story characters and/or other objects may include a magnetic or magnetic receptive material, for example, on a rearward facing surface of the character or object, that is magnetically attracted to the magnetic or magnetic receptive material in the narrative story backdrop, for enhancement of instruction using a thematic narrative story as described herein.

### Letter and Numeral Practice Cards

A plurality of cards may be provided, each of which includes a letter or numeral to be practiced (e.g., a solid, outline, or shaded depiction of a letter or numeral to be practiced). The cards may be of a dimension configured for insertion into the recessed area and above the writing surface of a reverse chalkboard cassette, or may be of different dimensions.

The cards may contain first and second solid lines and a dashed line between the solid lines, corresponding to the same lines on the reverse chalkboard cassette, as described above. The cards may contain first, and optionally second, writing area(s) corresponding to the same writing areas on the reverse chalkboard cassette, as described above. The lines and writing area(s) may be in the same color scheme as the reverse chalkboard cassette, providing consistent visual cues. The upper and lower solid lines and dashed line may be any color or combination of colors, and may optionally be designed to interface with a thematic backdrop or narrative story. One non-limiting embodiment includes a green upper line and a red lower line. In one embodiment, the dashed line is brown. Although numerous color combinations may be used, in some embodiments, the first writing area, between the upper and lower solid lines, is a white, off-white, or cream color. In some embodiments, the second writing area, if present, below the second solid line, is a gray color. A writing implement may be used that corresponds to the color produced by the writing implement that is used with the reverse chalkboard cassette, for example, black or gray, and the writing implement produces a black or gray writing stroke that is darker in color than the color of the first writing area, and also darker than the second writing area if present. For example, the writing implement may produce a writing stroke that is darker in color than the first writing area by a Munsell value of 2 to about 8, about 2 to about 4, or about 4 to about 8, or a difference of at least about 2, at least about 3, or at least about 4, at least about 5, at least about 6, at least about 7, or at least about 8. In some embodiments, the writing implement produces a writing stroke that is darker in color than the color of the second writing area, if present (e.g., darker by a Munsell value of about 2 to about 4, or at least about 2, at least about 3, or at least about 4) and that may be clearly seen on the darker colored writing area.

In some embodiments, illustrations of letters or numerals to be practiced are depicted on the cards, for example, a solid, outline, or shaded depiction of a letter or numeral to be practiced. The depicted letters or numerals may be in any color, but in one embodiment, they are in a gray color, and the writing implement produces a writing stroke, e.g., black or gray, that is darker in color than the color of the letter or numeral (e.g., darker than a shaded outline of a letter or numeral by a Munsell value of about 2 to about 4, or at least about 2, at least about 3, or at least about 4), such that writing strokes made by the therapist, instructor, or student on the card may be clearly seen over the depicted letter or numeral.

Optionally, one or more orientation indicator(s) may be included on the cards, optionally corresponding in theme to the narrative story, discussed above. In some embodiments, the cards include direction (e.g., arrow) and/or sequencing (e.g., number) indicator(s) for assisting with direction and/or sequencing, respectively, of writing strokes. In the non-limiting embodiment discussed above, where the narrative story involves a tree and birds and animals corresponding to the tree, the orientation indicator(s) may be in the form of a bird shown flying in the direction of writing strokes, corresponding to the top of the tree (e.g., for upper case letters or numerals) or an owl shown flying from the middle of the tree and optionally pointing in a vector direction with a wing to indicate a writing direction (e.g., for lower case letters), or a groundhog with head sticking out of a hole in the ground (e.g., for lower case letters than do not extend below the lower line) or shown tunneling underground (e.g., for the lower portions of lower case letters that extend below the lower line), optionally further including numbers and/or arrows to indicate sequencing and/or direction of writing strokes. Different characters and narrative stories may be used in other embodiments of the handwriting program.

The cards may be composed of cardstock, cardboard, laminate material, pressboard, paper, plastic or the like. The cards may be laminated for ease of reuse or may be designed for a single use with a pen or marker. In some embodiments, the cards may be made of or may include cellulose-based or pulp-based material, for example, that is water absorbent and may be written on with pens, pencils, markers, or the like. In some embodiments, the cards may include a write on/wipe off surface, such as a polymeric coating, such that the cards may be written on and reused.

The student may trace a depiction of a letter or numeral, for example, with a finger or a writing implement, such as a dry erase crayon or other non-permanent marker. Additionally or alternatively, the student may apply a sticky substance, such as double stick tape or adhesive (e.g., small adhesive dots from an adhesive dot dispenser), and place a solid (e.g., flexible) material, such as, but not limited to, pre-cut foam, e.g., cylindrical foam members, over the portions of letters or numerals represented on the card. For example, the foam may be made of polyurethane or polyethylene, with or without additives. Non-limiting examples of such foam material may be found in U.S. Pat. Nos. 5,498,190, 5,769,994, and 5,916,006.

After the student practices writing letters or numerals with the cards, the student may return to practicing on the reverse chalkboard cassette without the cards, if needed, to reinforce the proper formation of letters and numerals that were learned with the cards. Solid and dashed lines, and optional second writing area below the lower solid line, in the same configuration and color scheme on the reverse chalkboard cassette and the cards reinforces the starting upper (top) and stopping lower (bottom) lines and location of writing strokes between the start and stop lines, and optional writing strokes below the lower line for some lower case letters.

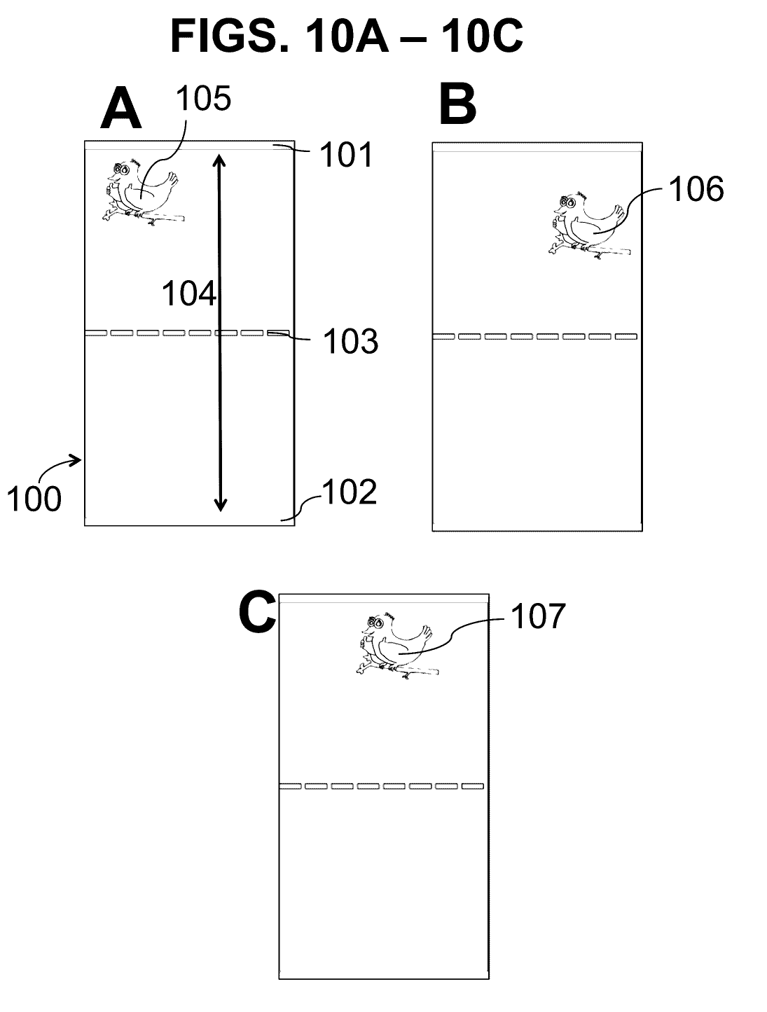

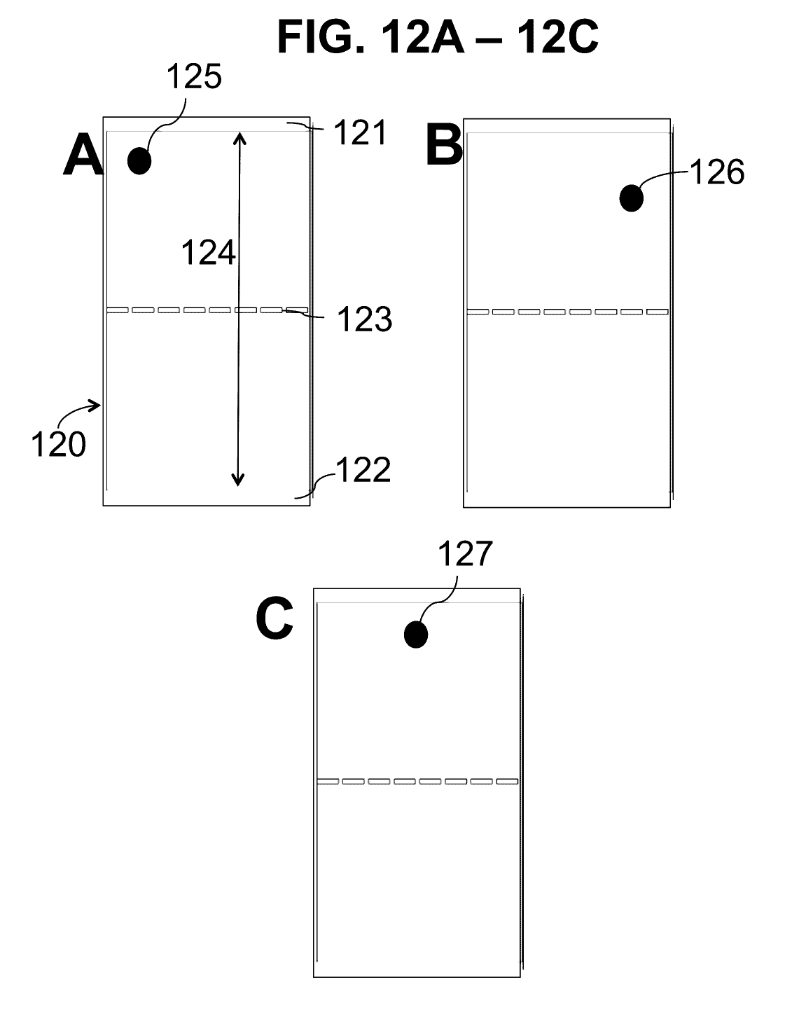

In some embodiments, the cards contain first and second solid lines, a dashed line, a first writing area, an optional second writing area, as described above and a top left, center, or right orientation indicator. An embodiment with dots as orientation indicators is depicted in FIGS. 12A-12C. FIGS. 12A-12C show a card 120 with a first solid line 121, a second solid line 122, and a dashed line, 123, with writing area 124 between the first and second solid lines. An orientation dot is located on the top left (FIG. 12A, 125), top right (FIG. 12B, 126), or top center (FIG. 12C, 127) portion of the writing area. An embodiment with a bird as an orientation indicator, e.g., corresponding in theme to an embodiment of a thematic narrative, is depicted in FIGS. 10A-10C. FIGS. 10A-10C show a card 100 with a first solid line 101, a second solid line 102, and a dashed line, 103, with writing area 104 between the first and second solid lines. A bird orientation indicator is located on the top left (FIG. 10A, 105), top right (FIG. 10B, 106), or top center (FIG. 10C, 107) portion of the writing area.

In one embodiment, the cards are made of a less durable substrate, such as paper. In such an embodiment, the cards are intended for a disposable use and may not include a surface for erasure and re-use. For example, a plurality of cards that include letter or numeral outlines, or just orientation indicators such as an upper left, center, or right dot or thematic element, such as a bird, and including lines and writing area(s) as described above may be provided in a tear-off pad from which single practice cards/sheets may be dispensed for disposable use. A tear-off pad may include practice cards that are all the same or may include a plurality of different practice cards.

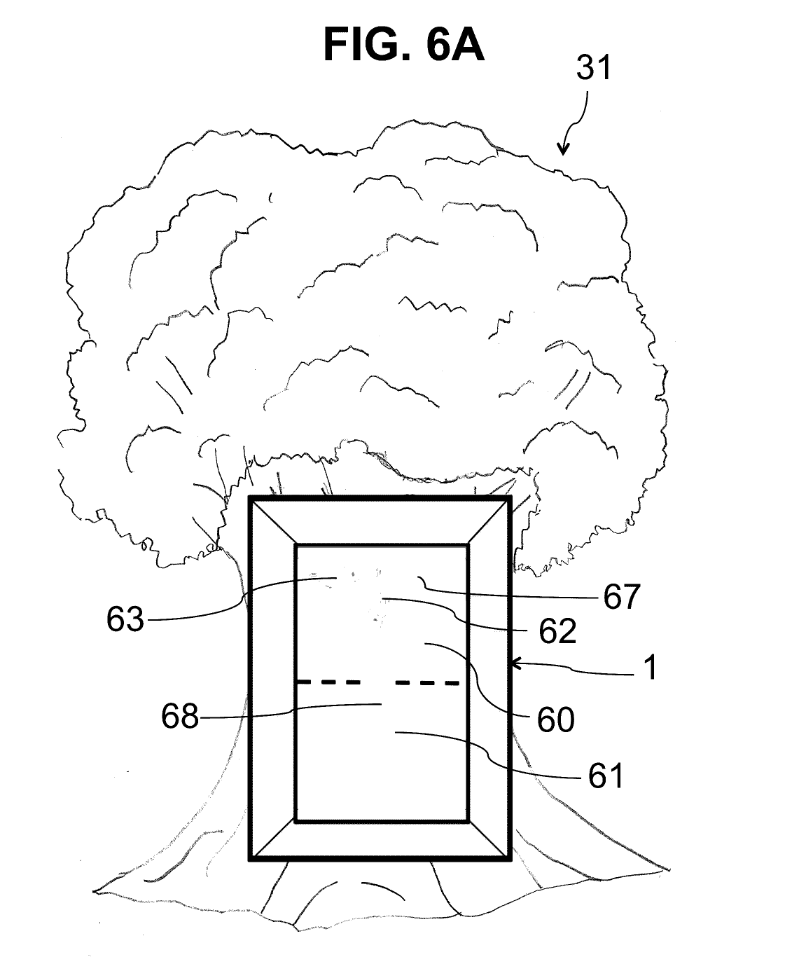

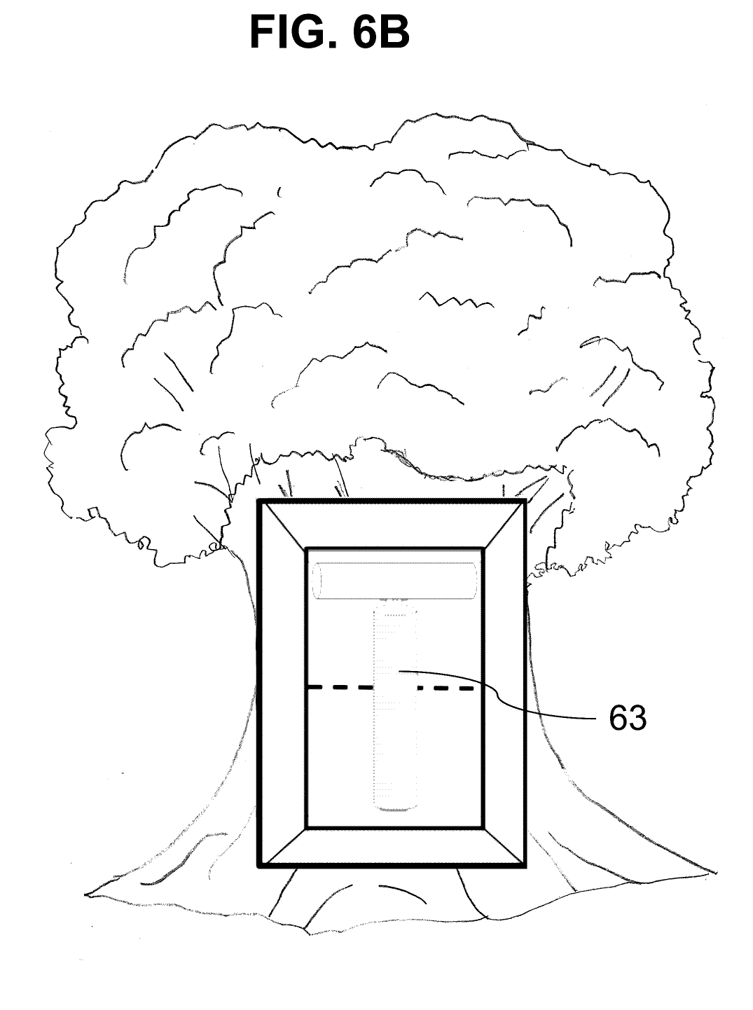

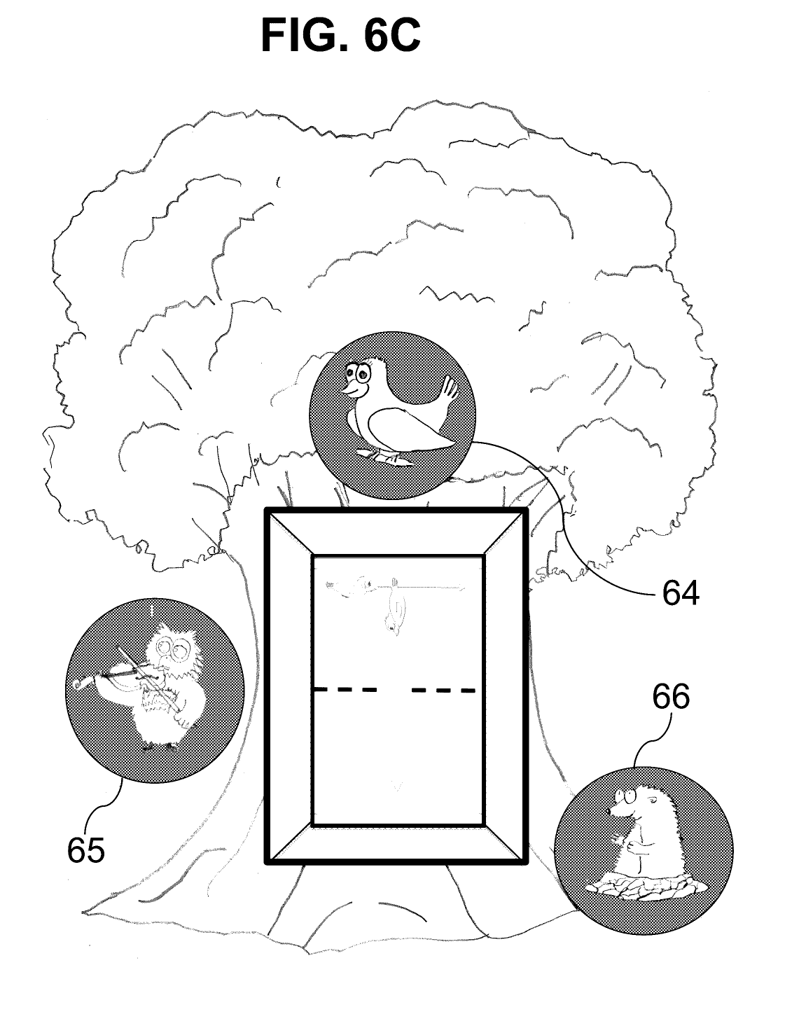

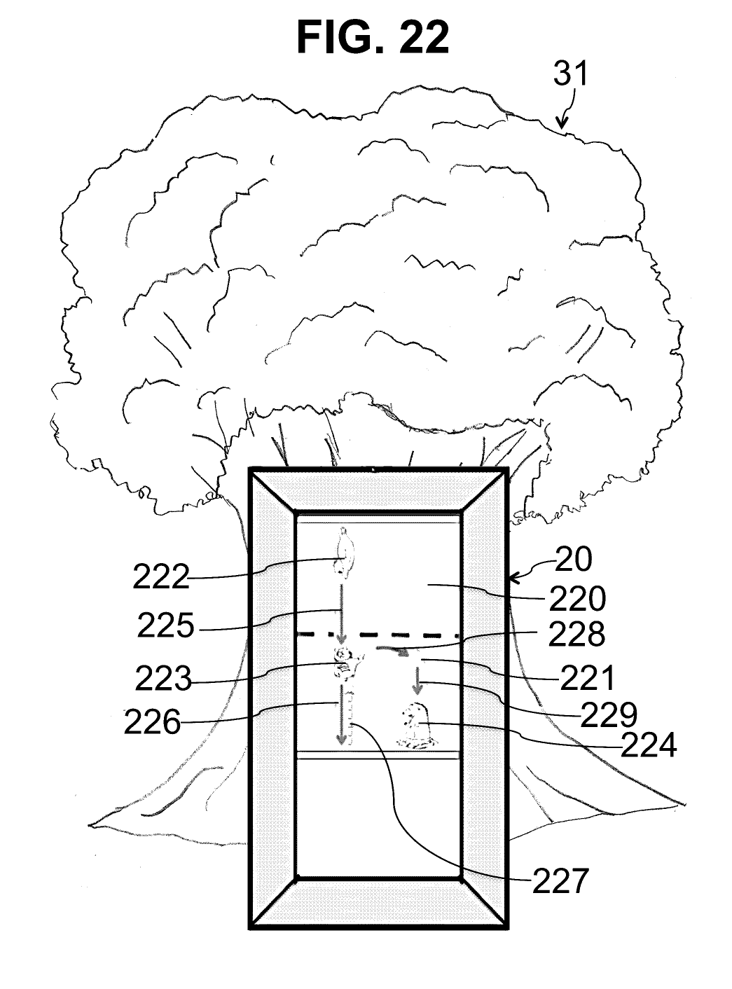

In some embodiments, the cards are of a dimension suitable for insertion into the recessed area of the reverse chalkboard cassette, as depicted in FIGS. 6A-6C and 22. FIG. 6A shows a practice card 60 with a shaded outline of the upper case letter “T” 61 inserted into the recessed area of a reverse chalkboard cassette 1 that is configured for instruction of upper case letters or numerals and which is mounted to a narrative backdrop 31. In the depicted card, narrative orientation indicators 62 and 63 are provided. Direction arrows 67 and 68 are also provided. FIG. 6B shows flexible material 63 placed over the letter that is printed on the card. FIG. 6C shows inclusion of “character chips” that depict characters that are thematically related to the backdrop and/or a narrative story, as described herein. Although bluebird 64, owl 65, and groundhog 66 characters are depicted in FIG. 6C, these characters are not intended to be limiting. Any characters or other objects may be used that enhance the backdrop scene or extend narrative story elements in conjunction with the methods and systems for handwriting instruction and remediation described herein. FIG. 22 shows a practice card 220 with a shaded outline of the lower case letter “h” 221 inserted into the recessed area of a reverse chalkboard cassette 20 that is configured for instruction of lower case letters and which is mounted to a narrative backdrop 31. In the depicted card, narrative orientation indicators 222, 223, and 224 are provided, as well as direction arrows 225, 226, 228, and 229 indicating writing strokes in a forward direction and dashed orientation/direction arrow 227 indicating a writing stroke in a retraced, reverse direction.

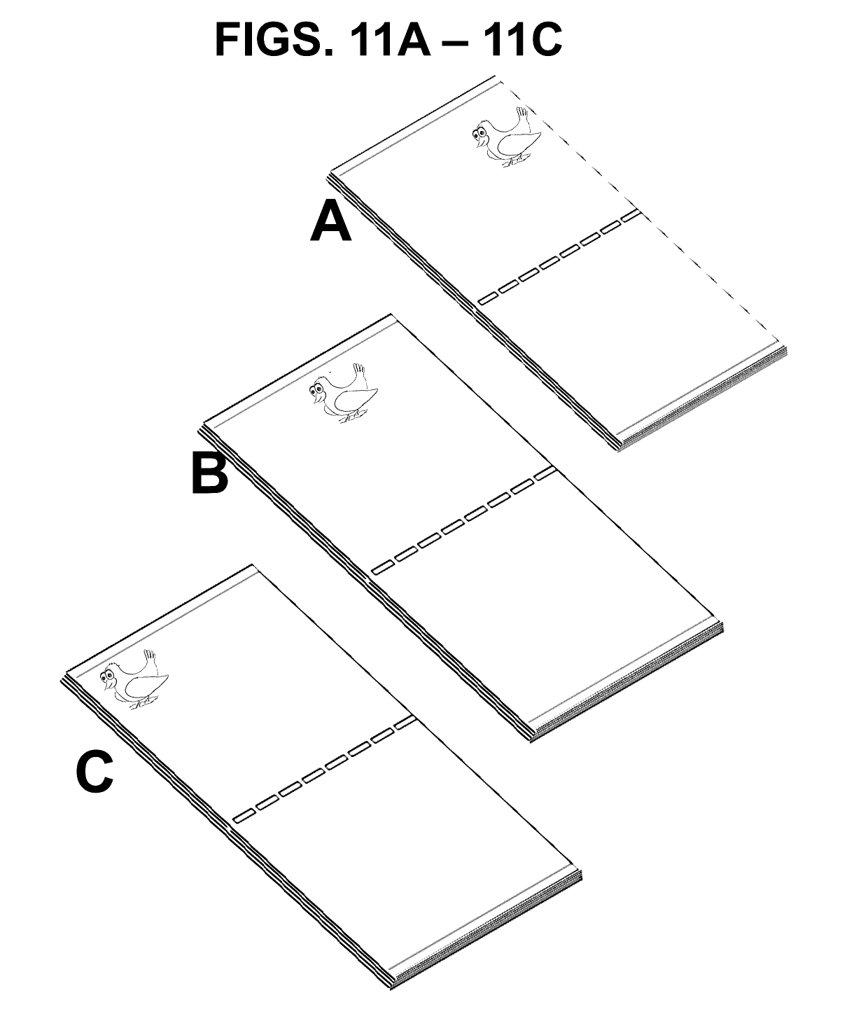

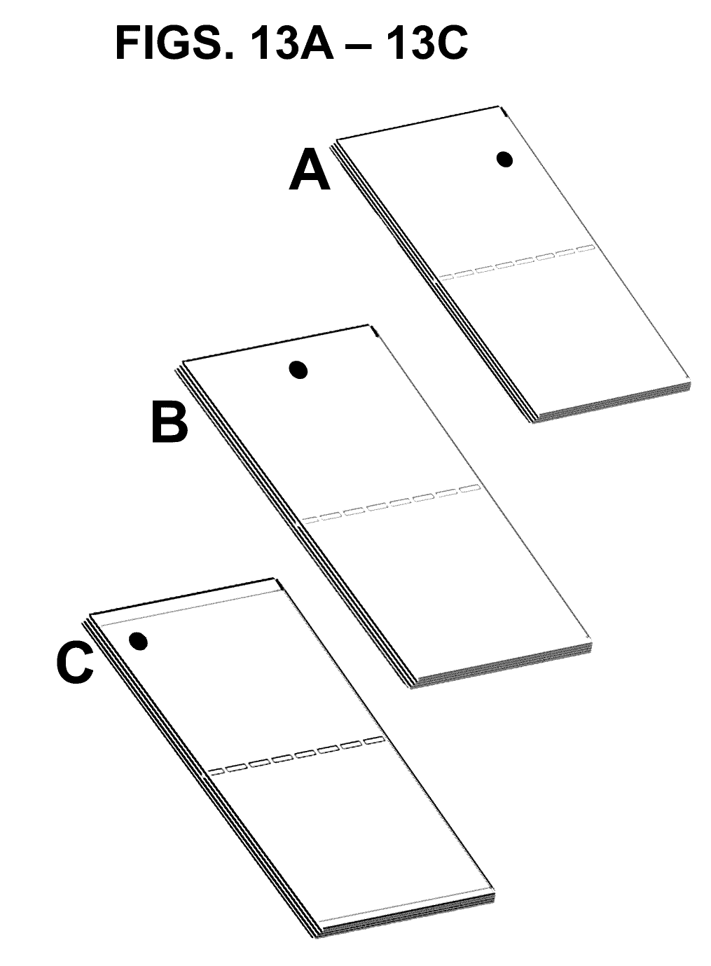

In some embodiments, practice cards are provided that include only a writing area, with an upper solid line, and lower solid line, and a dashed line between the upper solid line and the lower solid line, and optionally orientation(s). The practice cards may optionally be sized to fit in the recessed area of the reverse chalkboard cassette. In one embodiment, depicted in FIG. 10A-10C, practice cards include an orientation indicator that is a narrative story character (e.g., a bird) in the top left (FIG. 10A, 105), top right (FIG. 10B, 106), or top middle (FIG. 10C, 107) portion of the writing sheet. A plurality of practice cards may be provided as tear-off pads, as shown in FIGS. 11A-11C and 13A-13C. Optionally, the practice cards may include a dot or other geometric shape or object as an orientation indicator, as shown in FIGS. 12A-12C and 13A-13C. For instruction and practice of lower case letters, e.g., all lower case letters or lower case letters that include portions that extend below the lower solid line, a shaded writing area or a writing area that is in a different color than the writing area above the lower solid line may be included below the lower solid line.

### Bendable Material

A bendable material may be provided, which the student may manipulate to form letters or numerals. The bendable material may be used to provide proprioceptive and kinesthetic feedback, thus providing another medium for learning separate from tracing. This methodology provides a three dimensional, interactive platform that facilitates learning the shapes and the writing strokes required to form letters and numerals, and may be used to extend and enhance learning provided by two-dimensional media.

In one embodiment, the bendable material is composed of a cylindrical foam material with a wire inserted in the center. Typically, the bendable material is sized to be used independently of the reverse chalkboard cassette or practice cards, as described above, e.g., of a size that does not fit into the recessed area of the reverse chalkboard cassette. However, in some embodiments, the bendable material may be sized to be used in conjunction with these components of the handwriting instruction system.

The bendable material may be used to increase kinesthetic awareness of proper letter formation. Practice with a bendable material that forms letters or numerals of a larger size than the dimensions of the reverse chalkboard cassette or practice cards may teach the student how to form the letters or numerals on a large scale, which transfers to the ability to form letters or numerals on the chalkboard or practice cards, and to form letters or numerals with another material, for example, a flexible material such as pre-cut foam, in the context of the reverse chalkboard cassette and/or practice cards. Bending the bendable material also promotes grip strengthening and pinch strength, which promotes the motor skills required for effective pencil control.

The bendable material may be used as a first activity, for example, for students who have not had exposure to handwriting. Alternatively, the bendable material may be used as a supplement to another material in the system, such as reverse chalkboard cassette, practice cards, etc., when a student is having difficulty with a particular letter or numeral.

In some embodiments, the bendable material includes foam, e.g., cylindrical foam, such as polyurethane or polyethylene, with or without additives, with a wire, such as aluminum, e.g., 0-temper aluminum, inserted through the foam to impart manipulable and bendable functionality. A non-limiting example of such bendable foam material may be found in U.S. Pat. No. 5,498,190.

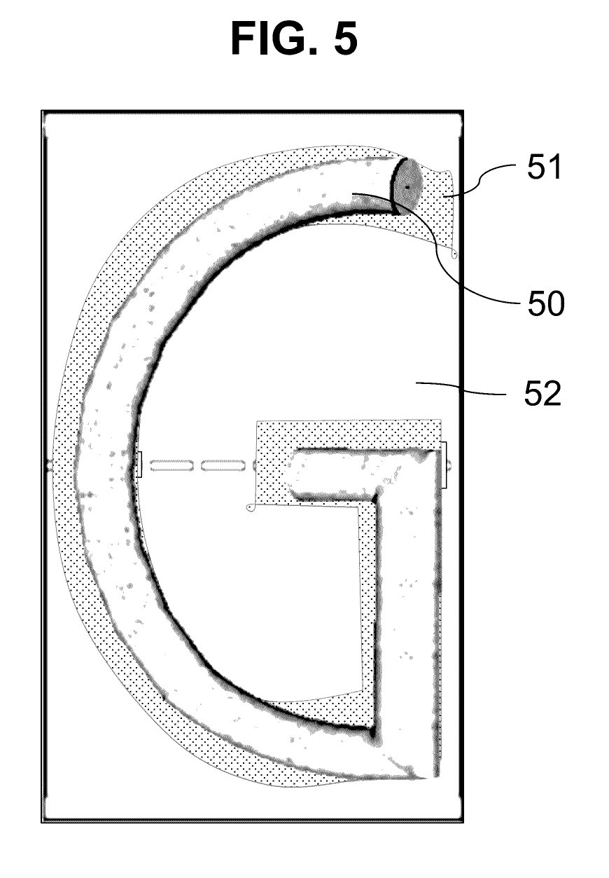

A depiction of one embodiment of use of a bendable material as described herein is shown in FIG. 5. Bendable material 50 is depicted as formed into the shape of a letter on an outline of the letter 51 on letter guide sheet 52.

### Writing Sheets

Writing sheets are also provided, and may be used in conjunction with the other handwriting instruction components described herein. For example, a plurality of writing sheets as described below may be bound together into a workbook for practicing handwriting skills, for example, a workbook for practicing upper case letters and numerals or a workbook for practicing lower case letters. In some embodiments, a plurality of writing sheets include writing blocks of successively smaller size, to assist the student in forming letters of successively smaller dimensions. Writing sheets may include solid lines, dashed lines, thematic story elements, orientation, direction, and/or sequencing indicators, or other elements that are the same or similar to those on the reverse chalkboard cassette and practice cards, as described above, for consisting visual cuing within the handwriting instruction or remediation program.

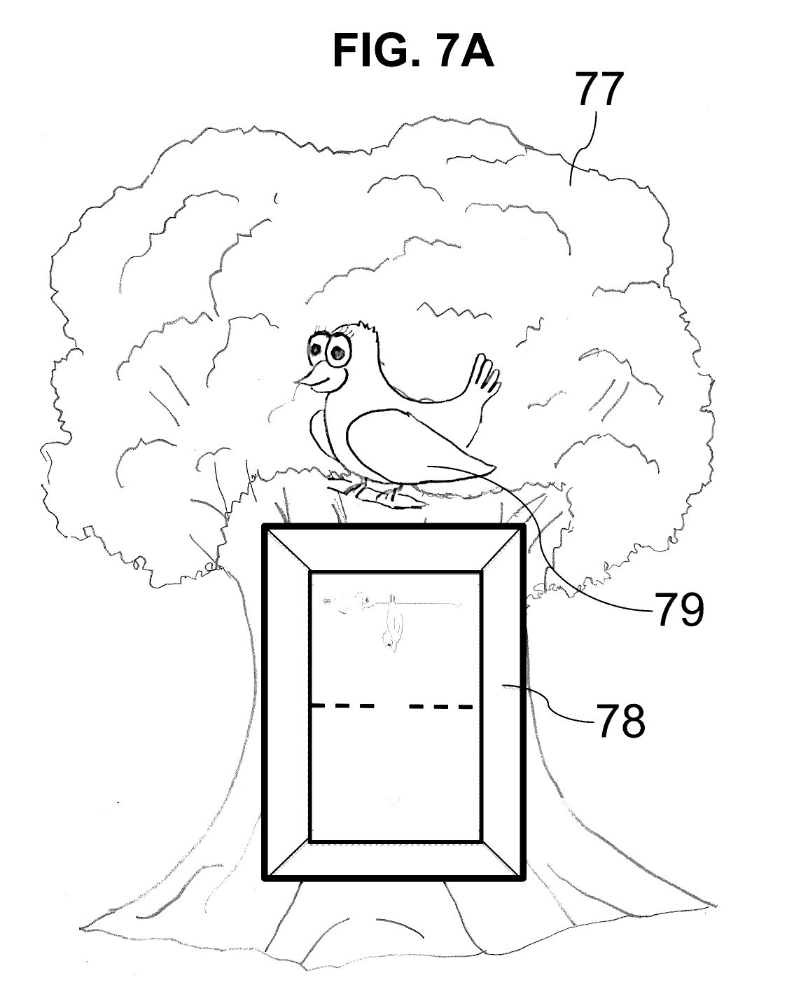

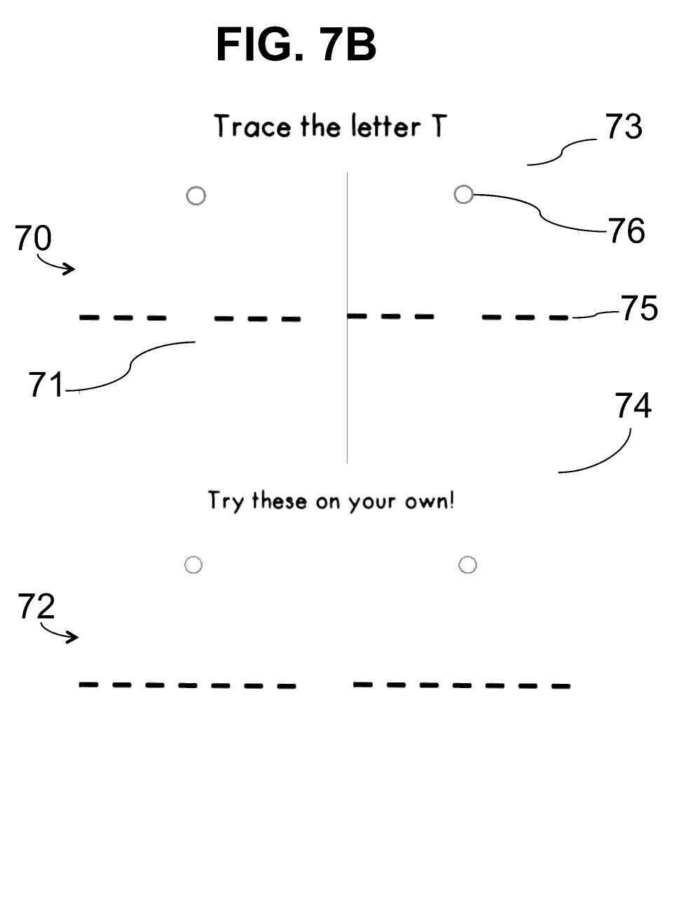

One embodiment of a writing sheet is depicted in FIG. 7A, in which the reverse narrative story backdrop 77 is depicted with a mounted reverse chalkboard cassette 78 into which a practice card is inserted that depicts upper case letter “T” and a narrative story character (a “bluebird”) 79 that is thematically related to the backdrop (a tree). The bird character is depicted on a tree branch above the reverse chalkboard cassette, providing orientation assistance to the student for writing the letter depicted on the card. The writing sheet embodiment depicted in FIG. 7A provides a fluent and consistent next step and directly transfers concepts and practices learned using the reverse chalkboard cassette, practice cards, and tree backdrop directly to writing sheets.

In some embodiments, a writing sheet includes one or a plurality of “writing blocks,” four-sided writing areas that are bounded on four sides by lines and/or shaded differently than the surrounding areas of the writing sheet, such that they provide a bounded writing area. A writing block may include a first solid line at the top or substantially at the top of the writing block, a second solid line, and a dashed line at an intermediate position between the first and second solid lines, wherein the area between the first and second solid lines provides a first writing area. In some embodiments (e.g., for instruction and/or practice of upper case letters and/or numerals), the second solid line is at the bottom or substantially at the bottom of the writing block. In other embodiments (e.g., for instruction and/or practice of lower case letters), the writing block includes a second writing area below the second solid line and extending to the bottom or substantially to the bottom of the writing block, optionally in a different color or shade than the first writing area. The writing blocks may illustrate a letter or numeral to be practiced, e.g., a solid, outline, or shaded depiction of the letter or numeral, and optionally may include orientation, direction, and/or sequencing indicators, optionally thematically related to a narrative story that is used throughout the handwriting instruction program. In some embodiments, a writing block may be depicted with, depicted within, or superimposed on a pictorial representation of at least one object that may be used to create a story to assist with handwriting instruction and that promotes spatial orientation for handwriting. In some embodiments, the writing block does not include an illustration of a letter or numeral to be practiced, but includes at least one orientation indicator, such as a top left, center, or right dot or pictorial representation of a thematic story element, for example, a bird or other story character.

One embodiment of a writing sheet is depicted in FIG. 7B, in which writing blocks 70 are provided for instruction and practice of upper case letters or numerals. A shaded depiction of an upper case letter “T” 71 is shown in writing blocks 70. The writing sheet also includes writing blocks 72 that do not include the shaded depiction of the letter, for free hand practice of the letter. Each writing block includes a solid upper line 73, a solid lower line 74, and a dashed line 75 between the upper and lower solid lines. Each writing block also includes an orientation indicator 76, to help orient the student for the beginning writing stroke for the depicted letter.

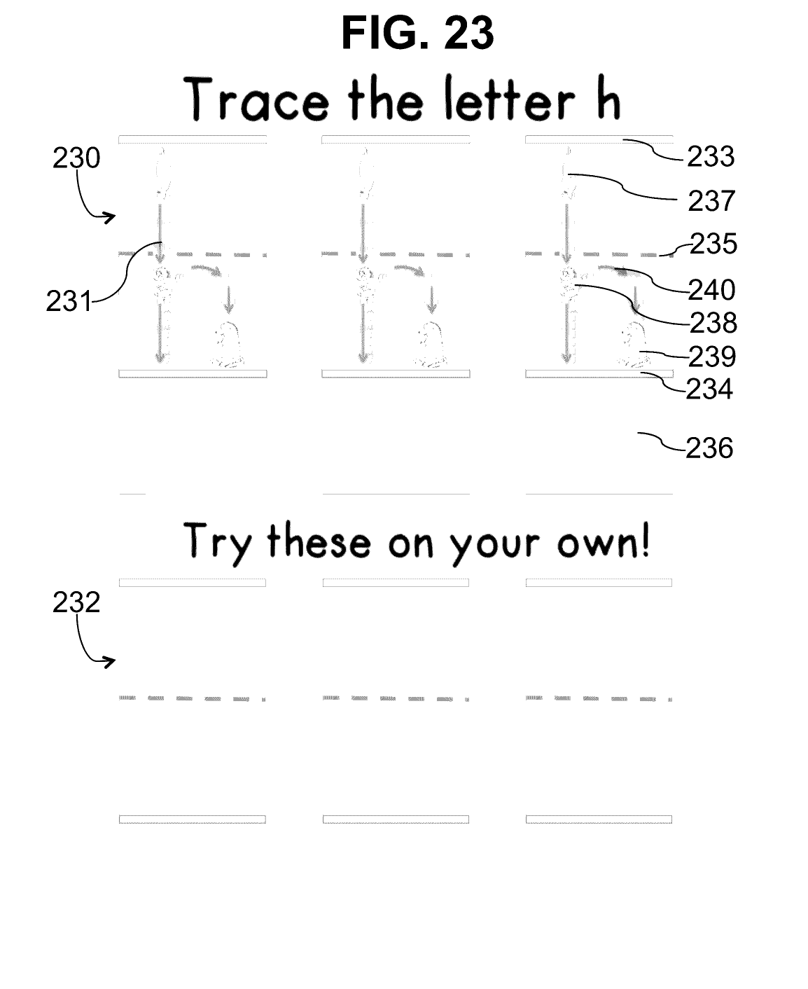

Another embodiment of a writing sheet is depicted in FIG. 23, in which writing blocks 230 are provided for instruction and practice of a lower case letter that is formed between the upper 233 and lower 234 solid lines and that does not extend into shaded area 236. A shaded depiction of a lower case letter “h” 231 is shown in writing blocks 230. The writing sheet also includes writing blocks 232 that do not include the shaded depiction of the letter, for free hand practice of the letter. Each writing block includes a solid upper line 233, a solid lower line 234, a dashed line 235 between the upper and lower solid lines, and a shaded area 236 below the lower solid line. Each shaded depiction of the letter to be practiced also includes an orientation indicators 237, 238, and 239, as well as arrows 240, to help orient the student for the beginning writing stroke for the depicted letter, for direction as formation of the letter progresses, and when to stop writing the letter when the lower solid line is reached.

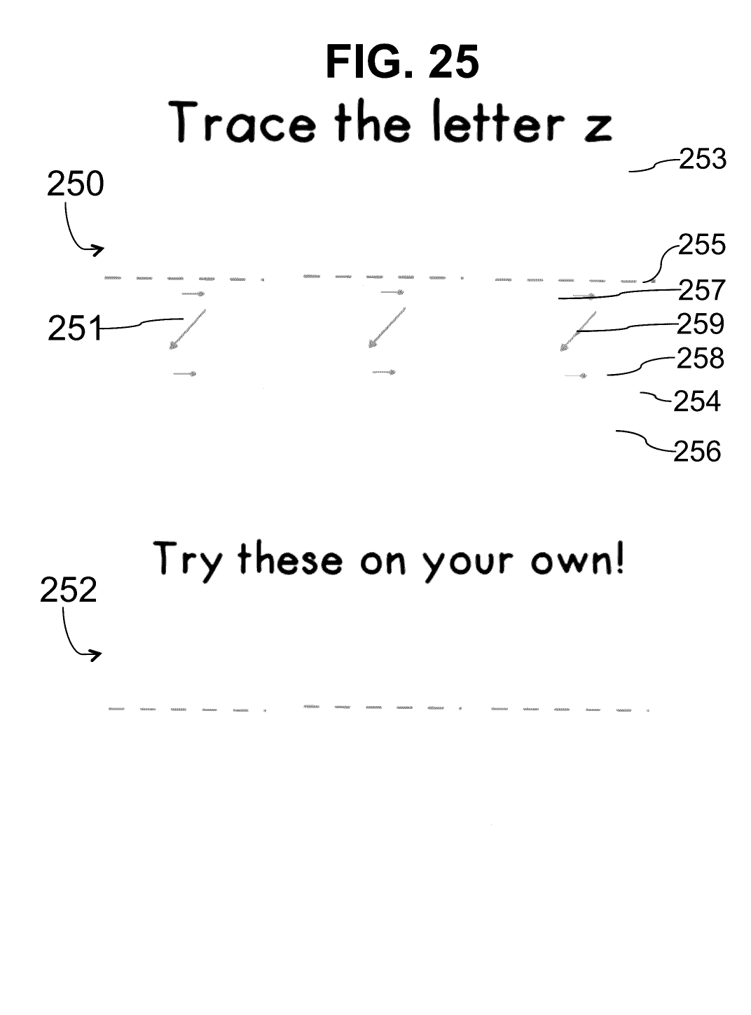

Another embodiment of a writing sheet is depicted in FIG. 25, in which writing blocks 250 are provided for instruction and practice of a lower case letter that is formed between the dashed 255 and lower solid line 254 and that does not extend into shaded area 256. A shaded depiction of a lower case letter “z” 251 is shown in writing blocks 250. The writing sheet also includes writing blocks 252 that do not include the shaded depiction of the letter, for free hand practice of the letter. Each writing block includes a solid upper line 253, a solid lower line 254, a dashed line 255 between the upper and lower solid lines, and a shaded area 256 below the lower solid line. Each shaded depiction of the letter to be practiced also includes orientation indicators 257 and 258, as well as arrows 259, to help orient the student for the beginning writing stroke for the depicted letter, for direction as formation of the letter progresses, and when to stop writing the letter when the lower solid line is reached. Numbers are also provided as sequencing indicators.

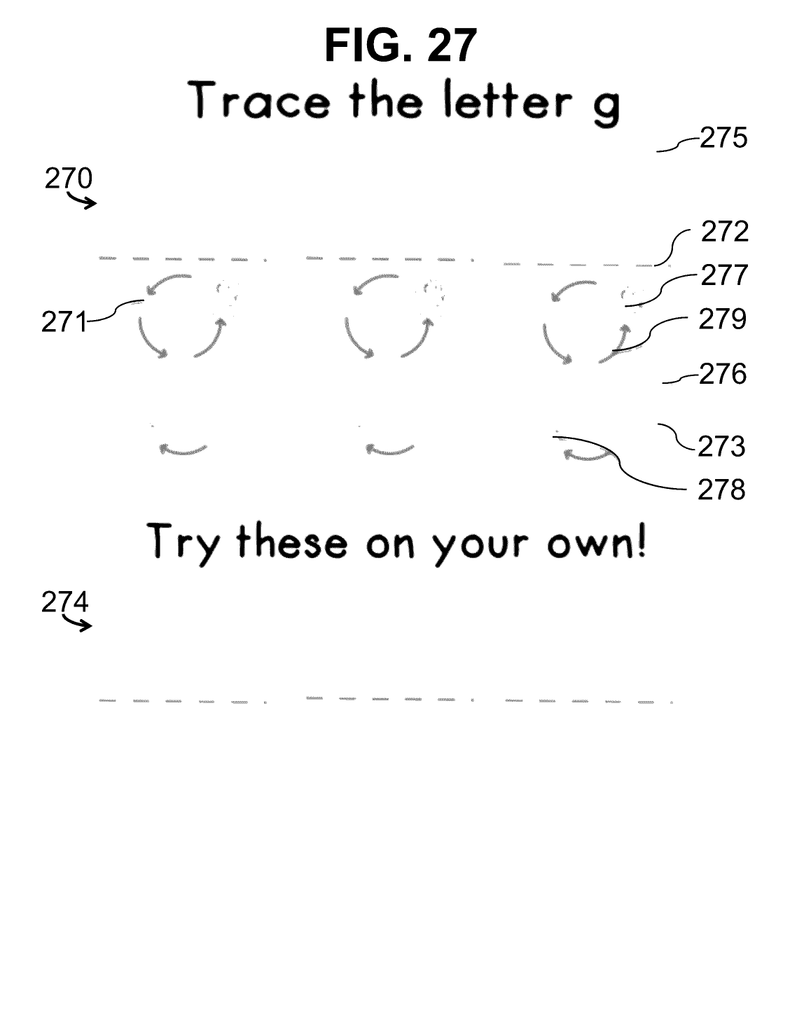

Another embodiment of a writing sheet is depicted in FIG. 27, in which writing blocks 270 are provided for instruction and practice of a lower case letter 271 that is formed starting at the dashed line 272 and extending into shaded area 273 below the lower solid line 276. A shaded depiction of a lower case letter “g” 271 is shown in writing blocks 270. The writing sheet also includes writing blocks 274 that do not include the shaded depiction of the letter, for free hand practice of the letter. Each writing block includes a solid upper line 275, a solid lower line 276, a dashed line 272 between the upper and lower solid lines, and a shaded area 273 below the lower solid line. Each shaded depiction of the letter to be practiced also includes orientation indicators 277 and 278, as well as arrows 279, to help orient the student for the beginning writing stroke for the depicted letter, for direction as formation of the letter progresses, and when to stop writing the letter when the lower solid line is reached. Numbers are also provided as sequencing indicators.

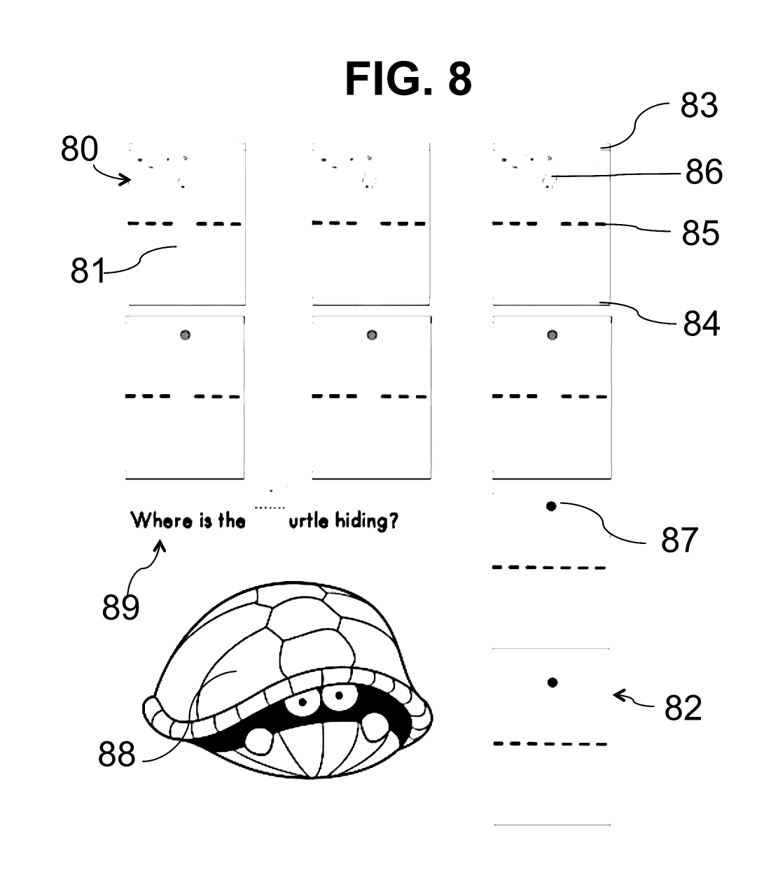

Another embodiment of a writing sheet is depicted in FIG. 8, in which writing blocks 80 are provided for instruction and practice of upper case letters or numerals. A shaded depiction of a capital letter “T” 81 is shown in writing blocks 80. The writing sheet also includes writing blocks 82 that do not include the shaded depiction of the letter, for free hand practice of the letter. Each writing block includes a solid upper line 83, a solid lower line 84, and a dashed line 85 between the upper and lower solid lines. Some writing blocks include narrative story characters as orientation and/or sequencing indicators 86, and some writing blocks include a dot 87 as an orientation indicator. The writing sheet depicted in FIG. 8 also includes a graphic 88 (a turtle) and an activity 89 (fill in the blank with the first letter of the graphic, which is also the letter to be practiced on the writing sheet) as a pneumonic to promote retention of the instructional activity.

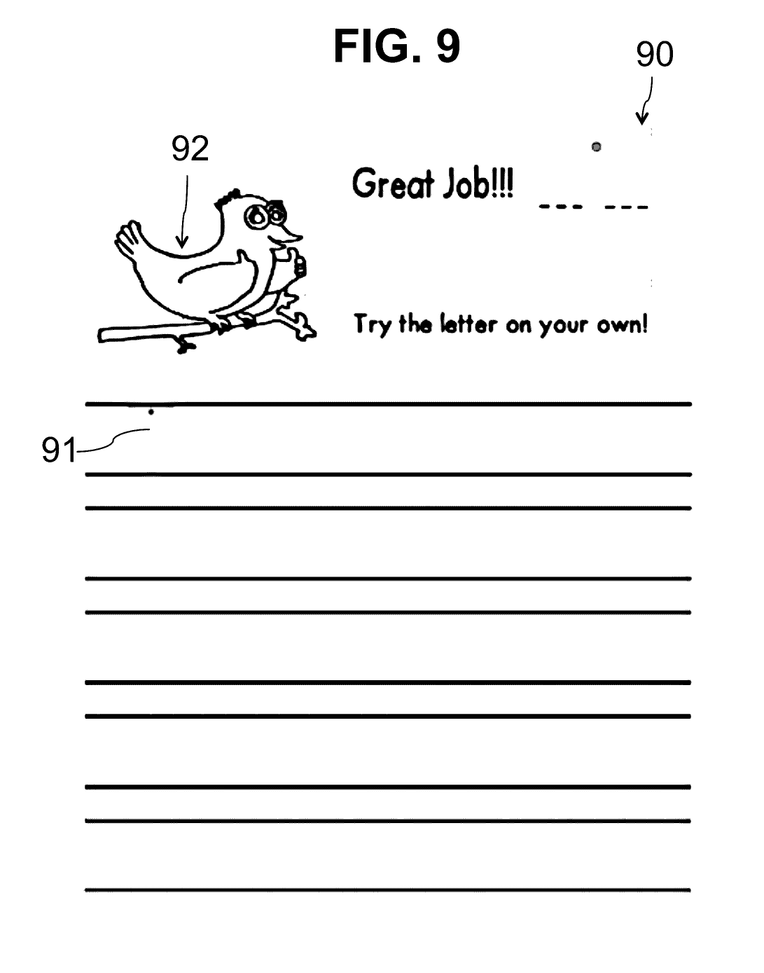

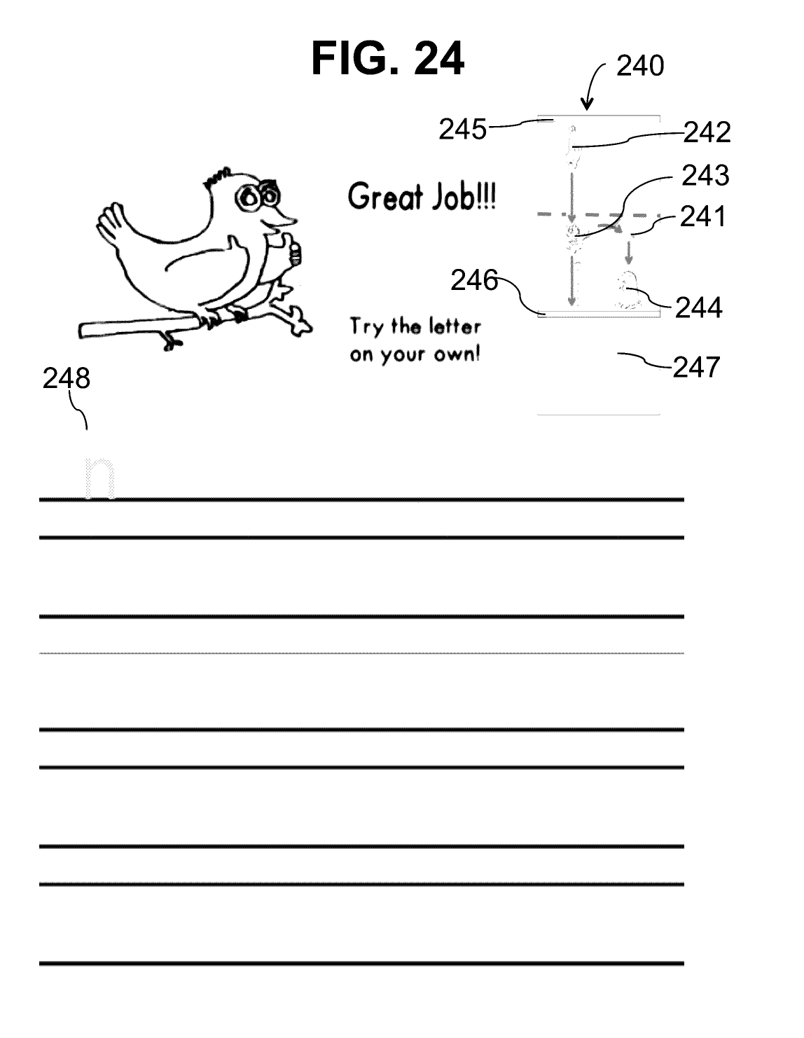

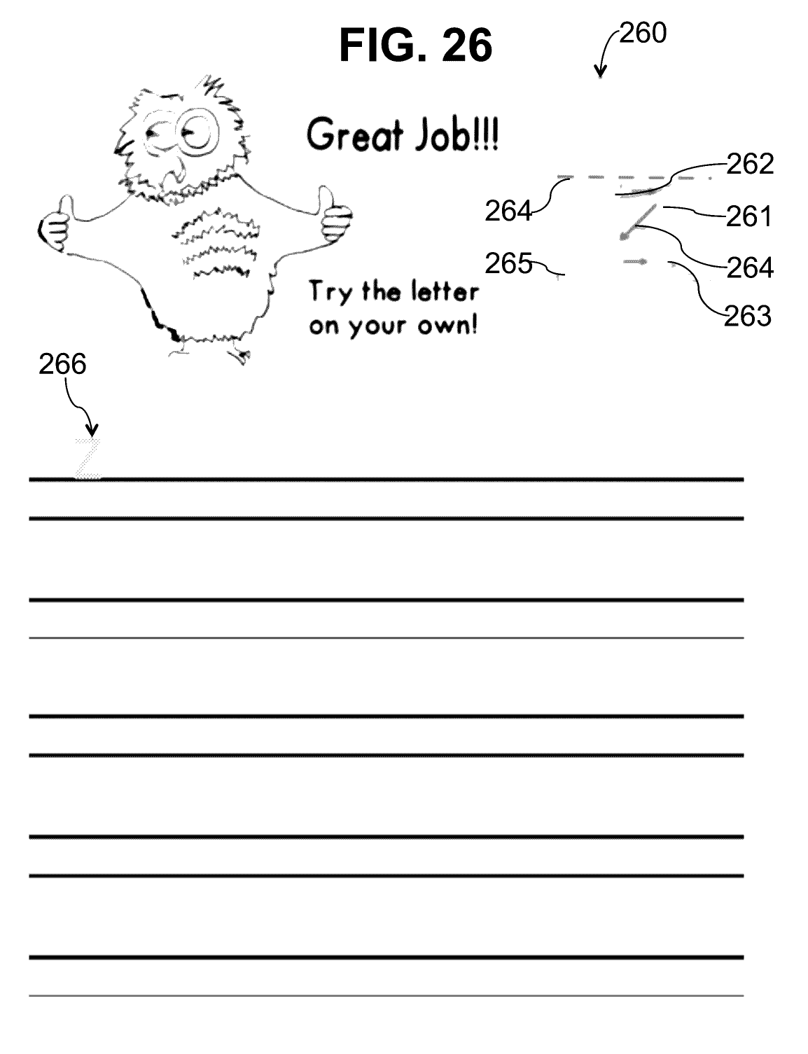

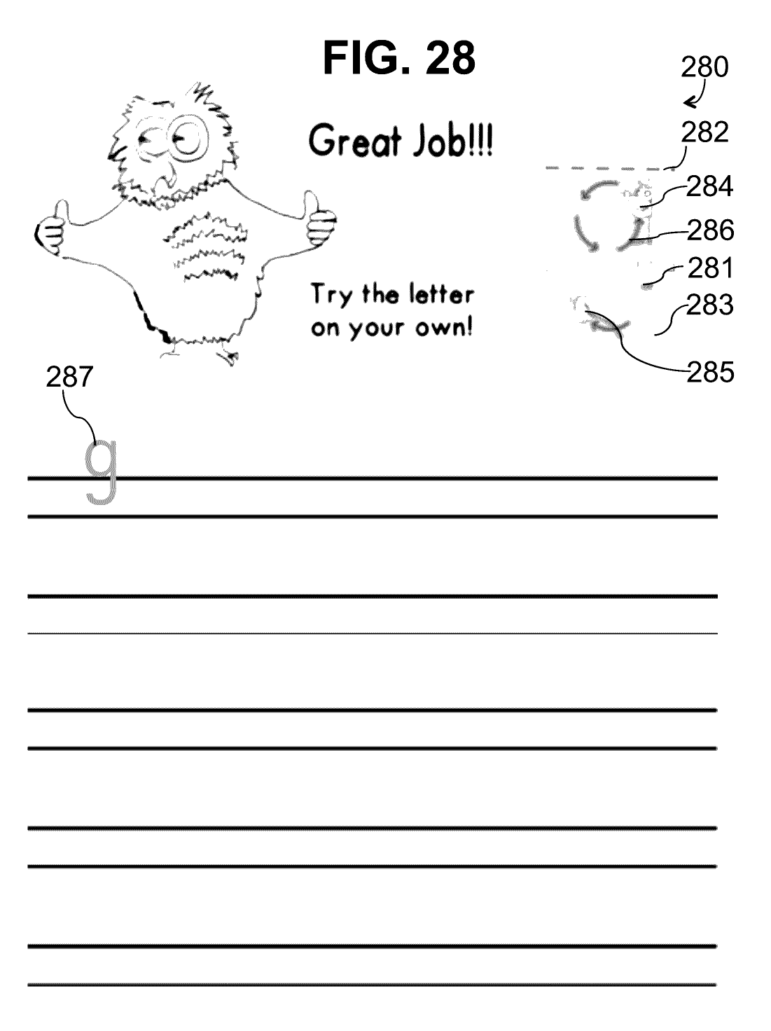

In other embodiments, a writing sheet includes lined writing paper, as described in further detail below, optionally also including a sample writing block indicating the letter or numeral to be practiced on the sheet. One embodiment of a writing sheet that includes a sample writing block for an upper case letter 90 is depicted in FIG. 9. The embodiment depicted in FIG. 9 also includes a shaded depiction 91 of the letter to be practiced on the lined writing area and a graphic 92 representing a character in a narrative story that has been used in conjunction with handwriting instruction. Another embodiment of a writing sheet, depicted in FIG. 24, includes a sample writing block 240 for a lower case letter that is formed between the upper 245 and lower 246 solid lines and that does not extend into shaded area 247 The embodiment depicted in FIG. 24 also includes a shaded depiction of the letter to be practiced on the lined writing area 248, as well as a shaded outline of the letter 241 in the sample writing block, orientation indicators 242, 243, and 244, and arrow direction indicators in the sample writing block. Another embodiment of a writing sheet that includes a sample writing block 260 for a lower case letter that is formed between the dashed line 264 and lower solid line 265 is shown in FIG. 26. The embodiment depicted in FIG. 26 also includes a shaded depiction of the letter to be practiced on the lined writing area 266, as well as orientation indicators 262 and 263, and arrow direction indicators 264 in the sample writing block. Another embodiment of a writing sheet that includes a sample writing block 280 for a lower case letter that is formed starting on the dashed line 282 and extending into shaded area 283 is shown in FIG. 28. The embodiment depicted in FIG. 28 also includes a shaded depiction of the letter to be practiced on the lined writing area 287, as well as orientation indicators 284 and 285, and arrow direction indicators 286 in the sample writing block. Numbers are also provided as sequencing indicators.

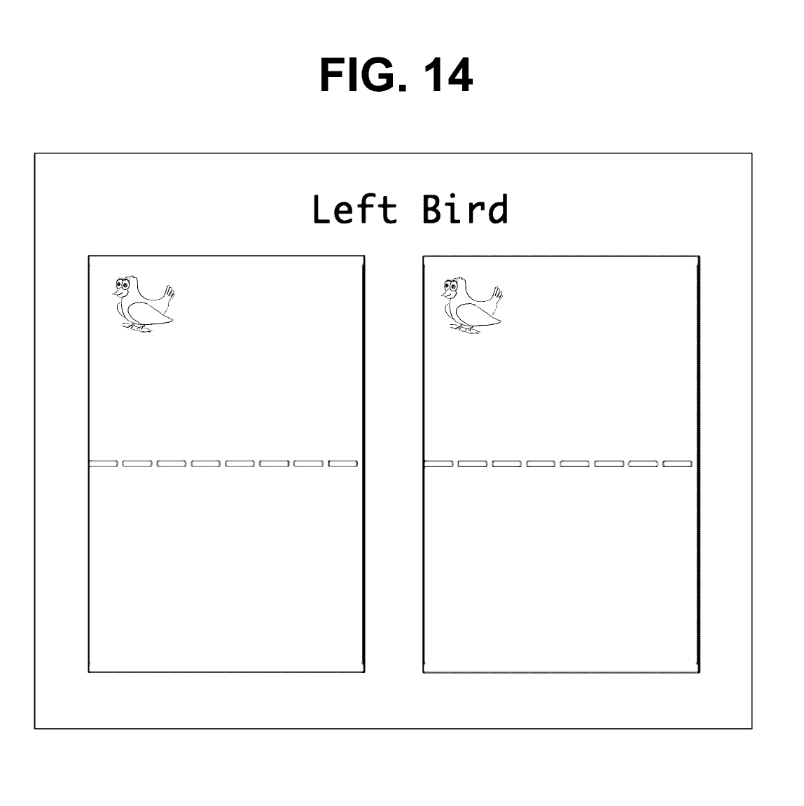

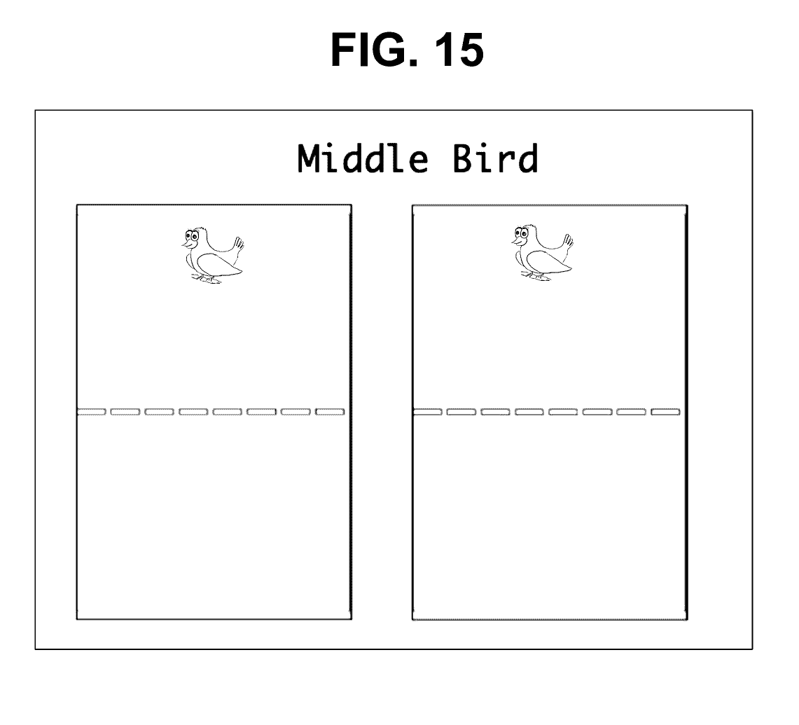

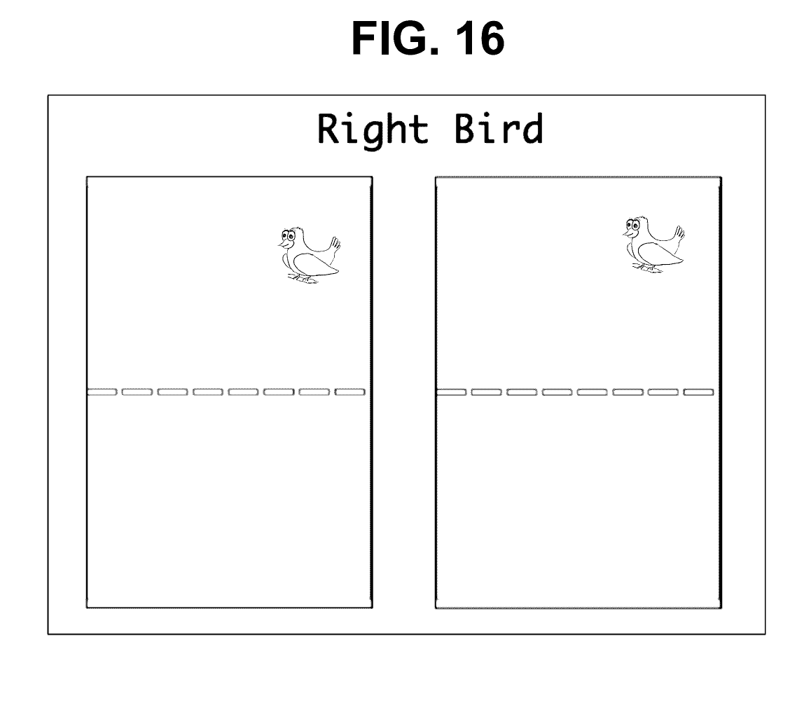

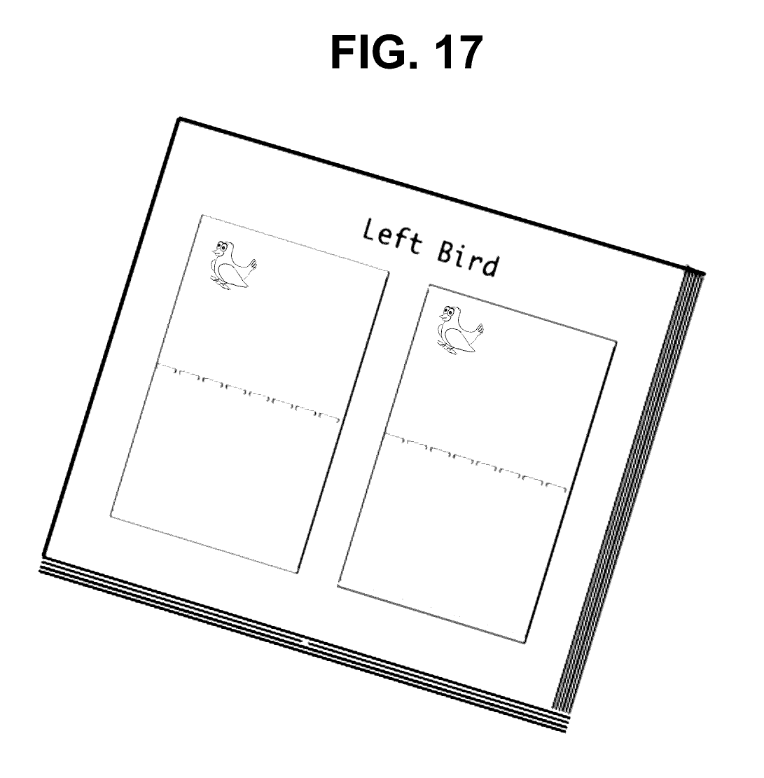

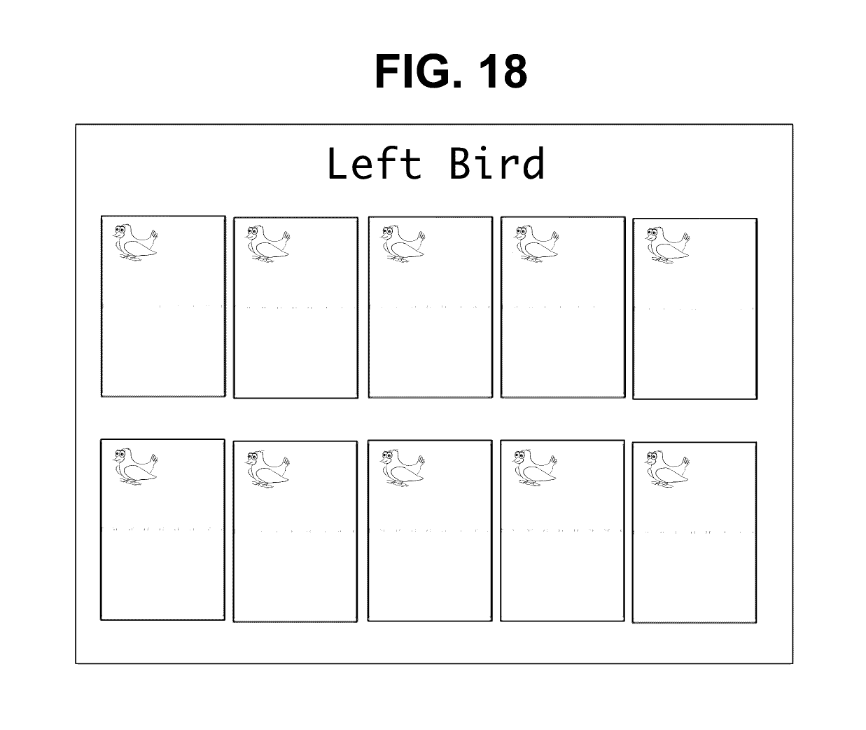

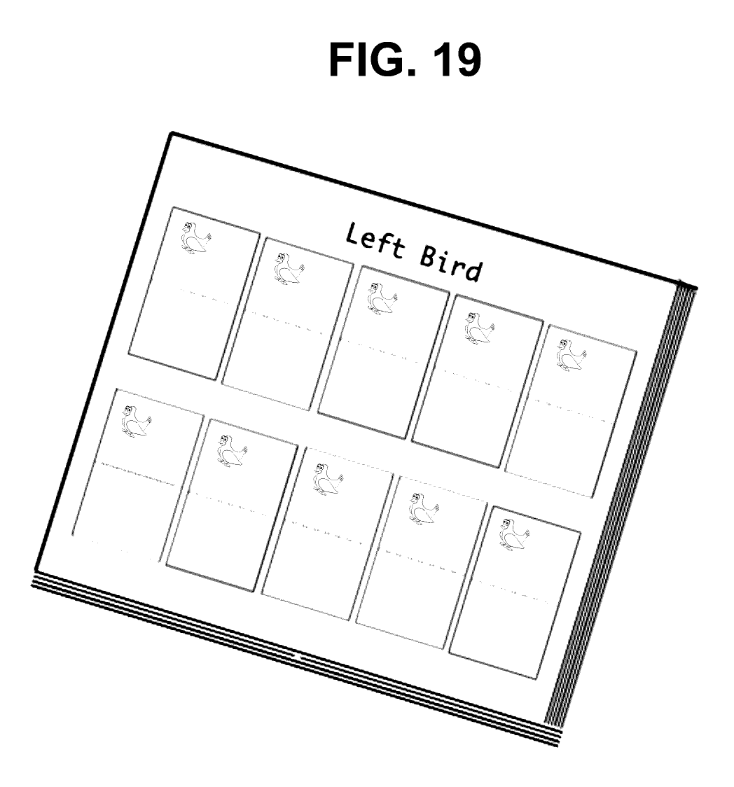

Other embodiments of writing sheets are depicted in FIGS. 14-19, in which a plurality of writing blocks is included on the sheet. The writing blocks may optionally include an upper solid line, a lower solid line, a dashed line between the upper solid line and the lower solid line, and orientation and/or sequencing indicator(s). For example, FIGS. 14, 15, and 16 depict writing sheets that include two writing blocks with an upper left (FIG. 14, “Left Bird”), upper middle (FIG. 15, “Middle Bird”), or upper right (FIG. 16, “Right Bird”) orientation indicator. For instruction and practice of lower case letters, e.g., lower case letters that include portions that extend below the lower solid line, a shaded area below the lower solid line may be included. A plurality of the writing sheets may be provided as a tear-off pad, as depicted in FIG. 17. Any number of writing blocks, with or without letter outlines, and with or without orientation, sequencing, and/or direction indicator(s), may be included on a sheet, for practice of letters or numerals of a desired size or dimension. For example FIG. 18 depicts a writing sheet that includes ten writing blocks, which sheet may optionally be included in a tear-off pad that contains a plurality of writing sheets, as depicted in FIG. 19. A tear-off pad may include writing sheets that are all the same or may include a plurality of writing sheets with different types and/or numbers of writing blocks.

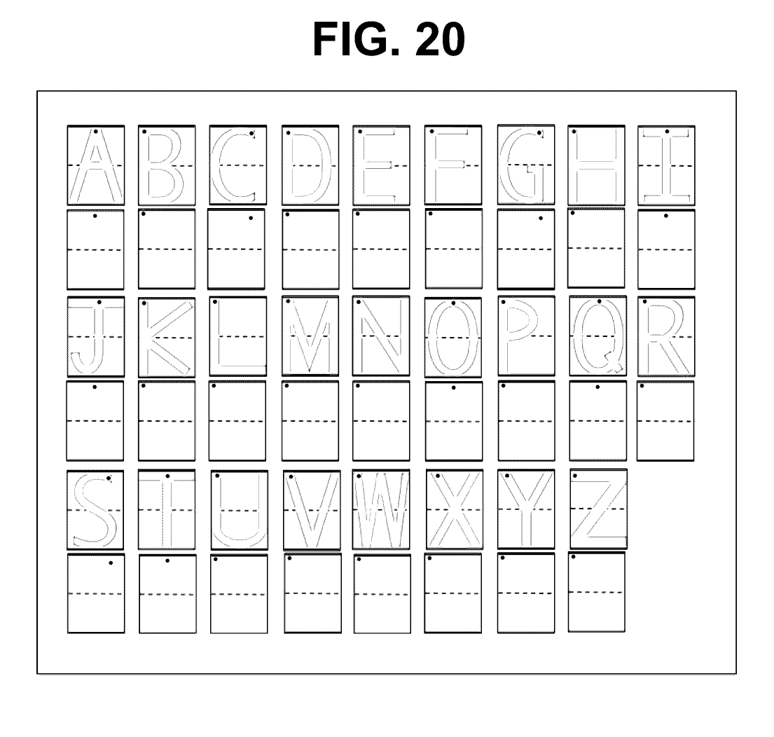

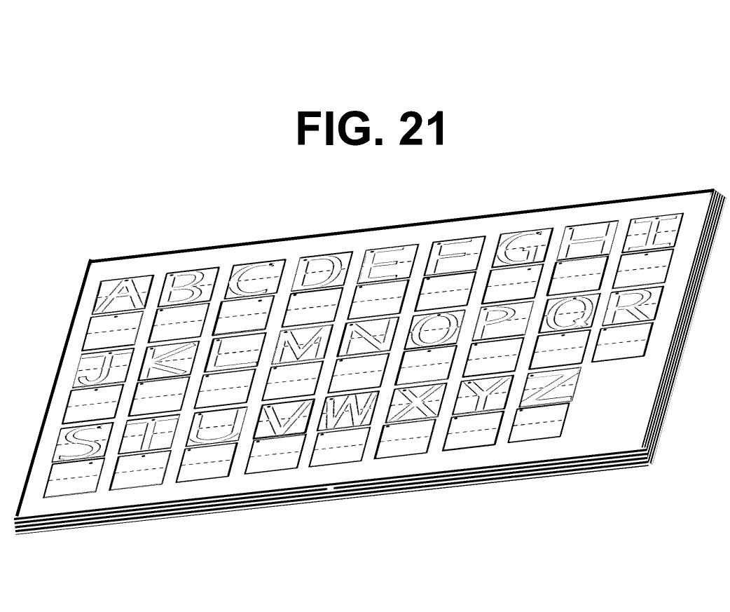

A writing sheet may include a plurality of writing blocks that are all the same, may include a plurality of different writing blocks, or may include a plurality of writing blocks in which some writing blocks are different and some are the same. An embodiment in which some writing blocks are different and some are the same is shown in FIG. 20. Some writing blocks on the sheet depicted in FIG. 20 are different (e.g., different upper case letters) and some are the same (e.g., writing blocks without shaded letters, including a plurality of the same writing blocks with upper left orientation indicators, a plurality of the same writing blocks with upper middle orientation indicators, and a plurality of the same writing blocks with upper right orientation indicators, each appearing underneath the letter for which the particular orientation indicator applies for the beginning writing stroke that should be used for forming the indicated letter). A writing sheet as depicted in FIG. 20 may be provided as a plurality of writing sheets in a tear-off pad, as depicted in FIG. 21.

In some embodiments, writing blocks and/or lined writing paper include color schemes that are the same or similar to those of other components of the handwriting instructions systems described herein, for example, solid lines, dashed lines, writing area(s), for consistent visual cueing for handwriting instruction. Although numerous color schemes are possible and are contemplated, in some embodiments, the upper solid line is green and the lower solid line is red. In some embodiments, the dashed line is brown. In some embodiments, the first writing area between the two solid lines is white, substantially white, off-white, cream color, beige, or light gray. In some embodiments, the second writing area, if present, below the lower solid line is gray, e.g., in a color or shade that is darker than the first writing area, e.g., darker by a Munsell value of about 2 to about 5, or at least about 2, at least about 3, at least about 4, or at least about 5. Other color schemes may be chosen to correspond to elements of a themed narrative story, as described herein. In some embodiments, a writing block includes a depiction of a letter or numeral to be practiced, e.g., a solid, outline, or shaded depiction, in a color or shade that is darker than the first writing area and darker than the second writing area, if present, e.g., darker than the first writing area between the two solid lines by a Munsell value of at about 2 to about 5, or at least about 2, or at least about 3, at least about 4, or at least about 5, and/or darker than the second writing area, if present, by a Munsell value of at least about 1.

In some embodiments, writing sheets include lined writing areas. In some embodiments, a writing sheet is provided that includes pairs of first and second writing areas in a repeating pattern in direction from the top to the bottom of the writing sheet. Each first writing area includes, printed on the sheet, a first solid line at the top of the first writing area, a dashed line, and a second solid line at the bottom of the first writing area, wherein the dashed line is at a position that is intermediate between the first and second solid lines, and wherein the first solid line, dashed line and second solid line are parallel or substantially parallel to each other. In some embodiments, the first and second solid lines may be in different colors and the dashed line may be in a third color. In some embodiments, the second writing area may be in a different color or shade that is darker than the first writing area. For example, the second writing area may be darker than the first writing area. In one embodiment, the second writing area is gray. In some embodiments, the second writing area is a darker color or shade than the first writing area, for example, darker than the first writing area by a Munsell value of about 2 to about 5, or at least about 2, or at least about 3, at least about 4, or at least about 5.

In some embodiments, the colors of the lines and writing areas correspond to the colors used in other components of the handwriting instruction system, as described herein, and/or are selected to correspond with a themed narrative story and/or backdrop. In some embodiments, the second solid line is raised from the surface of the writing sheet, providing a “stop” for downward writing stokes.

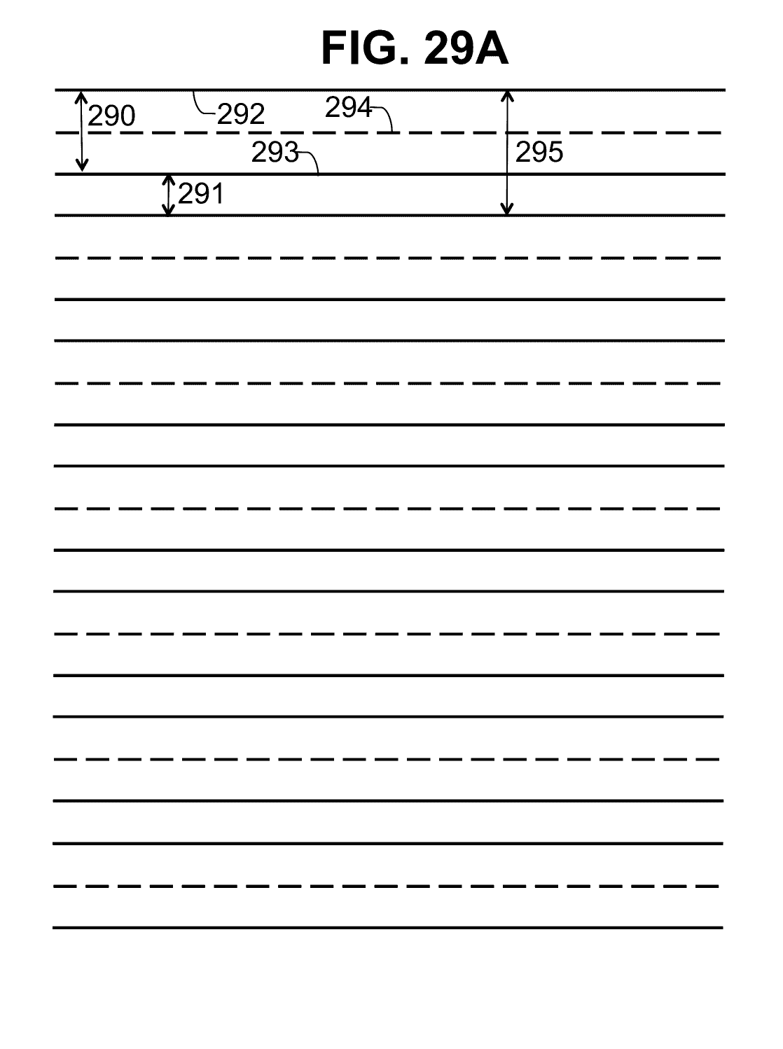

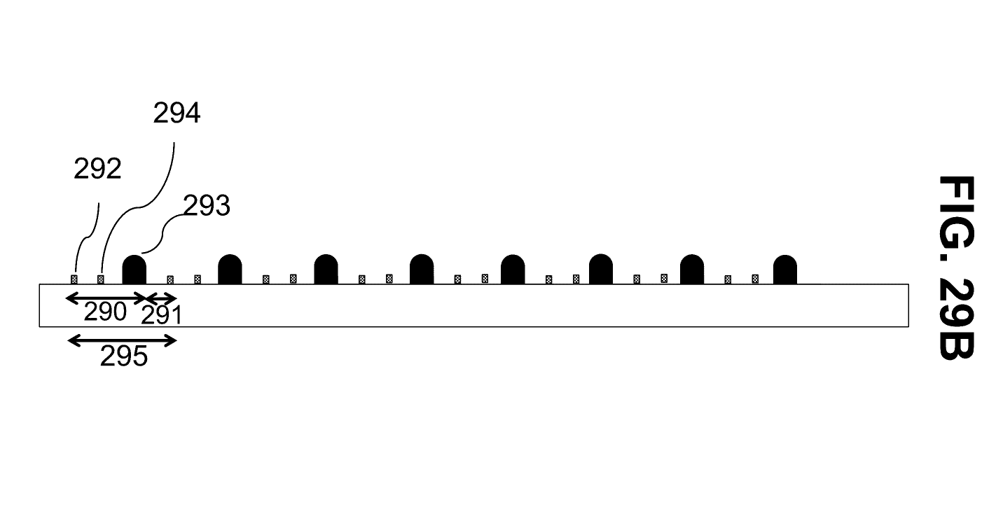

One embodiment of a writing sheet is depicted in FIGS. 29A-29B. As shown in FIG. 29A, the writing sheet includes a repeating pattern of first 290 and second 291 writing areas. The first writing area is between a first solid line 292 and a second solid line 293. The first writing area also includes a dashed line 294 between the first and second solid lines. In the embodiment depicted in FIG. 29A, the second writing area 291 is shaded darker than the first writing area 290. Pairs of first and second writing areas 295 may be repeated on all or a portion of the writing sheet. In some embodiments, the second solid line 293 is raised from the surface of the writing sheet, as shown in FIG. 29B.

In some embodiments, the first solid lines, second solid lines, and dashed lines may extend all the way to the edges or substantially to the edges of the writing sheet. In other embodiments, the first solid lines, second solid lines, and dashed lines do not extend all the way to the edges of the writing sheet.

In some embodiments, the first solid line is green and the second solid line is red. In some embodiments, the dashed line is brown. In one embodiment, the first solid line is green, the second solid line is red, and the dashed line is brown. In one embodiment, the first solid line is green and the second solid line is a raised red line. In one embodiment, the first solid line is green, the second solid line is a raised red line, and the dashed line is brown.

In some embodiments, an upper case letter or numeral is depicted in at least one first writing area on the writing sheet. In some embodiments, at least a portion of a lower case letter is depicted in at least one first writing area on the writing sheet. In some embodiments, a portion of a lower case letter is depicted in at least one second writing area of the writing sheet. In some embodiments, at least one first or second writing area includes one or more orientation, direction, and/or sequencing indicator(s).

### Electronic Media

In some embodiments, any of the materials or story narratives and backdrops as described herein can be provided in an electronic form, for example, as an application for use with a device, such as a touchscreen device, e.g., a mobile phone, tablet, or laptop or computer monitor with a touchscreen. For example, workbook materials, practice cards, and/or writing sheets, as described herein, may be provided in electronic form for handwriting practice. The student may practice writing strokes on a touchscreen surface using a finger, or with a stylus or other writing implement appropriate to the surface of the device to simulate use of a pencil or pen. Such systems permit and may employ the use of audio cues, feedback, and/or reinforcement, which may benefit all students, and, in particular, can support training for auditory learners. Audio/visual presentation may include animated versions of system components, such as the narrative story characters (e.g., bluebird, owl, and/or groundhog, or other characters that are thematically linked to a narrative story). These characters (e.g., animal or other story characters) may be used to guide students through letter formation, including potential recitation of the “social story” that accompanies each letter formation sequence. This system may also employ adjunct learning activities, such as interactive, electronic cartoons, consistent with the printed exercises, for example, exercises such as those that are exemplified in FIG. 8. Electronic systems of this type may also provide a mechanism for instructors to evaluate work conducted by the student on the device, including work that has been conducted at home, or at other remote settings, distant from the classroom or therapy room. In other embodiments, such electronic versions may be compatible with interactive schoolroom teaching systems, such interactive flat panel displays, interactive whiteboard systems, or any other electronic display device that may be used by teachers, therapists, or other instructors in a classroom or clinic setting.

### Methods for Handwriting Instruction

Handwriting instructional methods are provided using combinations of the components described herein. Any combination of the components may be used, and the starting point of the method may be adjusted depending on the skill level of the student.

Typically, the components are designed to be easy to use by the instructor. In general, the instructor will typically be, but is not limited to, an occupational therapist, physical therapist, speech-language pathologist, school/pre-school teacher, tutor, or parent, for example, in a home school environment. Parents or guardians can easily work with students using the component practice materials as assigned by the instructor.

In some embodiments, letters may be taught in order from easiest to hardest, from the perspective of the average handwriting learner. In one embodiment, upper case letters may be taught starting with “T,” then progressing to H, L, F, I, E, O, C, G, D, B, P, X, R, Q, V, W, Z, K, A, Y, M, N, U, J, and lastly S, although this order may be modified depending on the needs and learning style of the individual.

In some embodiments, an integrated method for handwriting instruction or remediation is provided that includes a plurality of the materials described above (e.g., reverse chalkboard cassette, practice cards, narrative backdrop, writing sheets, etc.) in which color schemes, lines construction, spatial orientation are the same or similar, providing consistent visual cues throughout the method of instruction.

The following examples are intended to illustrate, but not limit, the invention.

### EXAMPLES

### Example 1

An exemplary embodiment of a handwriting instruction or remediation method is provided below, although the embodiments described below are not intended to be limiting. The steps do not have to be practiced in the order below, all or a subset of the described sets may be practiced, and all or a subset of the described materials may be used. The system may be tailored to the needs of the student.

STEP 1: Introduce The Narrative Story: For example, for the narrative described above involving a tree and associated bird and animal characters, students are introduced to a story that contains three primary subjects: a bluebird, an owl with a violin (fiddle), and a groundhog. They all live in or around the tree.

Character Chips: Character Chips are provided to assist the instructor in recreating the story. In some embodiments, such chips are constructed using a shaped (e.g., circular) disk of wood, plastic, Masonite, Plexiglas, resin, or other material. A sticker containing a likeness of the bluebird, owl, groundhog, or other potential thematic element, is affixed to the character chip. Alternatively, the image may be painted directly onto the character chip. These markers give the student a playful introduction to elements of the program. In particular, by the end of this short introduction, the markers provide orientation to the writing lines and solidify in the students' minds where to begin creating each type of upper or lower case letter or numeral. From this point forward, students will strongly associate the bluebird with letters that begin at the top of the writing area, the owl with those that begin near the middle, and the groundhog, which demonstrates the stopping point for many letters and with those that cross below the red “stop” line.

STEP 2: Producing Letters Using Bendable Foam: Depending on the level of the student, the instructor may elect to begin the training process using bendable foam material that retains it shape when manipulated by the student. This process is particular valuable for students who are just beginning the process of learning handwriting. The foam elements are bent in the same way and sequence that letters will be later formed with a writing implement. Large-format letter templates are used to demonstrate the shape that the student needs to bend the material. The student follows the shape of the letter, bending the foam to the correct shape based on the accompanying start, stop, and middle lines, along with supplied orientation indicators. The bendable foam is particularly useful when demonstrating construction of letters which require retracing of the writing implement, such as “d.”

STEP 3: Using The Reverse Chalkboard: The reverse chalkboard cassettes are used to provide proprioceptive feedback and boundaries. The chalkboard frame guides and limits the letter size and aspect ratio and provides a physical boundary for both starting and stopping points. Red and green lines on the chalkboard provide a reference for starting and stopping letters. In some cases, the red and green lines may be raised. In these cases, the raised red and green lines themselves provide a physical writing boundary at the top and bottom of the reverse chalkboard cassette. A dashed line provides the reference to the center of the writing surface. The raised borders of the writing surface provide both a vertical and a horizontal boundary to limit the height, width, and aspect ratio of letters.

The instructor demonstrates the correct construction of each letter using dark colored chalk. The demonstrated letter is then not erased completely to leave a fainter image of the letter that the student can trace. Use of dark colored chalk on a light surface has been designed to provide a more accurate model of pencil-on-paper writing when compared with white chalk on a dark-colored board.

The board can than be wiped clean, for example, with a soft cloth or sponge, and the student is asked to form the letter independently as was just demonstrated. In some embodiments, if needed, the reverse chalkboard cassette can be wiped clean with a damp cloth moistened with water or mild soap (e.g., dish soap). Soap may not be required during the time of the session with students. If desired, the instructor can use a soap solution at the end of the session or workday to clean the surface completely.

STEP 4: Using Practice Cards to Guide Letter Formation: The student then creates letters on practice cards, such as laminated upper or lower case cards using small, pre-cut sections of flexible material, such as flexible foam strips. In some embodiments, the cards fit into a recessed area the reverse chalkboard cassette, as described above, to provide consistency when progressing between tasks.

The student may be asked to trace a letter or numeral depicted on a card with a sticky material, such as tape from a roll tape dispenser. This dispenser will apply a small amount of sticky material that permits attachment of the flexible material. Using a dispenser has the added benefit of promoting correct and effective tripod grasp. If desired, the instructor can ask the student to close his/her eyes and identify the shape of the letter by running a finger over the card where he/she has previously applied sticky tape. This procedure provides an additional sensory approach since it permits students to learn letter shapes kinesthetically.

The practice cards deliver a high level of flexibility to the instructor since they provide an adaptable platform for multi-sensory learning. For example, students can write on the cards directly using a writing implement, such as dry erase crayons or markers, with the cards inserted into a recessed area of the reverse chalkboard cassette or with the cards removed to be used on a flat surface. Utilizing the cards inserted into the reverse chalkboard cassette, which itself is attached to the tree-shaped backboard as a reference, continues to reinforce spatial cues that assist the student with correct starting and stopping points for letter construction as they progress to this phase of the program. Adding the cards directly to the reverse chalkboard cassette also provides a smooth transition from writing with chalk on the reverse chalkboard cassette to writing with different implements on the cards. The instructor may also elect to apply shaving foam or other slippery substance to the card for additional sensory feedback.

STEP 5: Drawing Letters Using Smaller and Smaller Templates With Progressively Less Spatial Guidance: Writing blocks imprinted with a bluebird or dots at the top are provided to progress to using a pencil. Students then work using progressively smaller workbook tracing templates until they can perform successfully on writing sheets with a raised lower line as described above.

Once the student can form letters effectively on the writing sheets, the instructor may transition the student to standard kindergarten paper. The raised lower line paper is particularly useful for the student who continues to have difficulty knowing where to “stop” writing during construction of upper case letters or numerals.

Lower Case Letters: The method described above may be used for instruction of upper case letters first, and then repeated for instruction of lower case letters. Lower case letters are generally taught after completion of upper case letters. Procedures for teaching lower case letters are identical to those for the upper case and may be introduced from the easiest to hardest letters to form. Letters may be grouped according to the spatial starting point on the practice card templates.

In the non-limiting example described above with a tree and associated bird and animal characters, “tree toppers” may be introduced first, where writing of each letter starts at the “top of the tree where the bluebird sits on a branch.” This corresponds to the upper (e.g., green) line on the paper. The “tree topper” letters are l, t, f, k, h, b, and d presented in that order, although the order may be modified in accordance with the needs and/or learning style of a particular student. Writing of the “middle fiddler” letters start on or near the middle (dashed) line. These letters are also introduced in order of complexity, starting with i, and progressing through a, c, o, r, m, n, u, x, v, w, z, s, and e in that order, although the order may be modified in accordance with the needs and/or learning style of a particular student. The groundhog character comes into play here as well to cue the student where to stop these letters on the bottom (e.g., red) line. Next, the “groundhogger” letters are taught, which include j, y, g, p, and q, in that order, although the order may be modified in accordance with the needs and/or learning style of a particular student. In forming these letters the student is instructed that they “dig” underground in the corresponding shaded area. Only five of the lower case letters cross below the “stop” (e.g., red) lower line into this shaded area. For a consistent learning experience, this shaded area may correspond to analogous areas on all of the other materials, including but not limited to, the lower case reverse chalkboard cassette, laminated practice cards, other lower case writing blocks, and on the raised-line writing paper. As a fun adjunct project, students may design a special “pass,” “badge,” or other embodiment to allow portions of these five special letters to cross the “stop” line.

The lower case reverse chalkboard cassette is longer than the upper case reverse chalkboard cassette (e.g., as depicted schematically in FIGS. 1A-1D) and contains a shaded section below the lower line (see, e.g., FIG. 2A-2D). This added area of the lower case reverse chalkboard cassette is critical for teaching that, in writing, some spaces are intentionally left blank. Sometimes it is helpful to label an empty salt shaker or small pump spray bottle with the word “NOTHING.” Instruct the student to “shake” or “spray” “nothing” into that space.

For the student who begins with pre-existing handwriting knowledge, the above program can be adapted at any point to accommodate individual needs. For example students frequently reverse lower case b and d. If this is the student's only issue, then more time may be spent constructing the letter with large bendable material and/or small flexible material, then progressing through reverse chalkboard cassettes, to the writing blocks on paper, and finally lined kindergarten-style paper.

In some embodiments, workbook pages corresponding to each letter may include a cartoon image with which the student is asked to complete a fun, spatially oriented activity. This activity promotes spatial awareness and provides an engaging task not directly related to tracing or forming letters. As such, the activity has direct application to learning lettering while giving the student a short, entertaining break from direct letter tracing and other related activities.

The final activity provided in the workbook may be an area to practice letter fill in context of a word that contains the just-learned letter. The cartoon image noted above, along with its related word, may provide a helpful pneumonic to promote retention. Research has shown that students retain letter formation when used as part of a word. The workbook page may include a lined segment, consistent with components from the remainder of the system, which permits the student to fill in the letter that is missing from the pneumonic word example.

### Example 2

Tests were conducted with four different instructors and 7-8 students per instructor who were in need of handwriting instruction or remediation, using the method described in Example 1. The instructors were Senior Occupational Therapists and the students were a plurality of children on their caseloads with differing needs for handwriting instruction or remediation. Feedback was positive for all students tested. No feedback was received that the system was ineffective with any particular subtype of student. Instructors for all four of the test groups reported that the students were highly engaged with the system and that the students would see the tree and other materials on the table and want to use it. The instructors also reported that they were able to address handwriting with students who otherwise would not “sit” and do handwriting and other programs and techniques. It was reported that students who would not attend to handwriting instruction using other systems would work for 30 min using this program. An improvement in students' attention was reported, with an ability to engage in handwriting activities for longer periods of time than with previously-used handwriting instruction systems. The students also were reported as having fun, with less resistance to handwriting in general. It was also reported that students who previously struggled with attention and focus during handwriting instruction demonstrated marked improvement using this method, and that the students enjoyed the stories that went along with the letter strokes.

Although the foregoing invention has been described in some detail by way of illustration and examples for purposes of clarity of understanding, it will be apparent to those skilled in the art that certain changes and modifications may be practiced without departing from the spirit and scope of the invention. Therefore, the description should not be construed as limiting the scope of the invention.

We claim:

1. A device for handwriting instruction, comprising:
a writing surface comprising a top and a bottom, and further comprising a first solid line at the top or substantially at the top of the writing surface, a dashed line, and a second solid line, superimposed on the writing surface,
wherein the area between the first and second solid lines comprise a first writing area,
wherein the dashed line is located at an intermediate position between the first solid line and the second solid line,
wherein the first solid line, the second solid line, and the dashed line are parallel or substantially parallel to each other, and
wherein the writing surface comprises a material on which writing strokes, letters, or numerals may be formed with a writing implement and erased for reuse of the surface.

2. A device according to claim 1, wherein the writing surface comprises a high pressure laminate.

3. A device according to claim 2, wherein the high-pressure laminate is in accordance with European Standard EN 438 and ISO 4586.

4. A device according to claim 1, wherein the writing surface comprises a painted surface or printed sticker comprising a clear coating.

5. A device according to claim 4, wherein the clear coating is selected from clear chalkboard paint, epoxy, lacquer, polyurethane, varnish, and/or other clear or protective finish.

6. A device according to claim 1, wherein the second solid line is at the bottom or substantially at the bottom of the writing surface

7. A device according to claim 1, wherein the second solid line is located at an intermediate position between the dashed line and the bottom of the writing surface, and
wherein the writing surface comprises a second writing area below the second solid line and extending to the bottom or substantially to the bottom of the writing surface.

8. A device according to claim 1, wherein the first solid line, the second solid line, and the dashed line are different colors.

9. A device according to claim 8, wherein the first solid line is green and the second solid line is red.

10. A device according to claim 9, wherein the dashed line is brown.

11. A device according to claim 7, wherein the first writing area is a first color and the second writing is a second color.

12. A device according to claim 11, wherein the first and second colors differ by a Munsell value of at least about 3.

13. A device according to claim 1, wherein the first writing surface further comprises one or more orientation indicator(s).

14. A device according to claim 1, wherein the first writing surface is comprised within a raised surface and forms a recessed area within the raised surface.

15. A device according to claim 14, wherein the raised surface comprises a frame.

16. A system for handwriting instruction, comprising a device according to claim 1, and further comprising a narrative story backdrop that depicts at least one object that may be used to create a story to assist with handwriting instruction and that promotes spatial orientation for handwriting,
wherein the device is configured to reversibly attach to the backdrop or to fit within a recess in the backdrop.

17. A system according to claim 16, wherein the backdrop depicts a representation of a live tree.

18. A system according to claim 16, further comprising accessory items to enhance the story to assist with handwriting instruction and/or to promote spatial orientation for handwriting.

19. A system according to claim 16, wherein the backdrop depicts a live tree and the accessory items comprise birds and/or other animals that live in or around the tree, and/or one or more bird nests.

20. A system for handwriting instruction, comprising a device according to claim 1, and further comprising a writing implement,
wherein the writing implement is capable of forming writing strokes, letters, or numerals on the writing surface,
wherein the first writing area is a first color,
wherein the writing strokes, letters, or numerals formed by the writing implement are darker than the first writing area by a Munsell value of at least about 2.

21. A system according to claim 20, wherein the writing implement provides proprioceptive feedback when used to form writing strokes on the writing surface.

22. A system according to claim 20, wherein the first color is white, substantially white, off-white, or cream color, and the writing implement produces black or gray writing strokes.

23. A system according to claim 20, wherein the writing implement comprises dark colored chalk.

24. A system according to claim 23, wherein the chalk is black or gray

25. A system for handwriting instruction, comprising a device according to claim 7, and further comprising a writing implement,
wherein the writing implement is capable of forming writing strokes, letters, or numerals on the writing surface,
wherein the first writing area is a first color,
wherein the second writing area is a second color, and
wherein the writing strokes, letters, or numerals formed by the writing implement are darker than the second writing area by a Munsell value of at least about 2.

26. A system according to claim 25, wherein the writing implement provides proprioceptive feedback when used to form writing strokes on the writing surface.

27. A system according to claim 25,
wherein the first color is white, substantially white, off-white, or cream color,
wherein the second color is gray, and
wherein the writing implement produces black or gray writing strokes that are darker than the second writing area by a Munsell value of at least about 2.

28. A system according to claim 25, wherein the writing implement comprises dark colored chalk.

29. A system according to claim 28, wherein the chalk is black or gray.

30. A system for handwriting instruction, comprising a device according to claim 14, and further comprising a plurality of cards each depicting a letter or a numeral, and/or one or more orientation indicator(s) printed on the card, wherein the cards are configured to fit within the recessed area.

31. A system according to claim 30, wherein the cards comprise a surface that may be written on and erased.

32. A system according to claim 30, comprising a plurality of cards each depicting a letter or numeral and each further comprising one or more orientation, direction, and/or sequencing indicators.

33. A system according to claim 30, wherein the cards comprise a writing area comprising a first solid line, a dashed line, and a second solid line, in the same or similar configuration as the writing surface of the device into which the cards are inserted.

34. A system according to claim 30, further comprising a flexible material that may be placed on top of the printed letters or numerals on the cards.

35. A system according to claim 34, wherein the material that may be placed on top of the printed letters or numerals comprises foam.

36. A system according to claim 34, further comprising an adhesive material that may reversibly adhere the flexible material to the card.

37. A system for handwriting instruction, comprising a device according to claim 1 and a bendable material for forming letters or numerals.

38. A system for handwriting instruction, comprising a writing sheet,
wherein said writing sheet comprises one or more writing block(s), said writing block(s) comprising a top and a bottom, and further comprising a first solid line at the top or substantially at the top of the writing block, a dashed line, and a second solid line at the bottom or substantially at the bottom of the writing block,
wherein the area between the first and second solid lines comprise a first writing area,
wherein the dashed line is located at an intermediate position between the first solid line and the second solid line, and
wherein the first solid line, the second solid line, and the dashed line are parallel or substantially parallel to each other.

39. A system according to claim 38, wherein the writing sheet comprises a plurality of writing blocks.

40. A system according to claim 38, wherein the writing block further comprises a depiction of a letter or numeral between the first and second solid lines and superimposed over the dashed line.

41. A system according to claim 38, wherein the writing block further comprises one or more orientation, direction, and/or sequencing indicator(s).

42. A system according to claim 38, wherein the writing block is depicted within a pictorial representation of at least one object that may be used to create a story to assist with handwriting instruction and that promotes spatial orientation for handwriting.

43. A system according to claim 38, wherein the first solid line is green and the second solid line is red.

44. A system according to claim 43, wherein the dashed line is brown.

45. A system for handwriting instruction, comprising a writing sheet according to claim 38,
wherein the writing block comprises a second writing area below the second solid line and extending to the bottom or substantially to the bottom of the writing block.

46. A system according to claim 45, wherein the writing sheet comprises a plurality of writing blocks.

47. A system according to claim 45, wherein the writing block further comprises a depiction of a letter or between the first and second solid lines and superimposed over the dashed line, between the dashed line and the second solid line, or starting at the dashed line and extending into the second writing area.

48. A system according to claim 45, wherein the writing block further comprises one or more orientation, direction, and/or sequencing indicator(s).

49. A system according to claim 45, wherein the writing block is depicted within a pictorial representation of at least one object that may be used to create a story to assist with handwriting instruction and that promotes spatial orientation for handwriting.

50. A system according to claim 45, wherein the first solid line is green and the second solid line is red.

51. A system according to claim 49, wherein the dashed line is brown.

52. A system according to claim 45, wherein the second writing area is a different color or shade than the first writing area.

53. A writing sheet for handwriting instruction comprising a top and a bottom, comprising, in a direction from top to bottom, a repeating pattern of a first writing area followed by a second writing area,
wherein each first writing area comprises, from top to bottom, a first solid line at the top of the first writing area, a dashed line, and a second solid line at the bottom of the first writing area, wherein the dashed line is at a position that is intermediate between the first and second solid lines,
wherein the first solid lines, second solid lines, and dashed lines of first writing areas are printed on the sheet and are parallel or substantially parallel to each other,
wherein the first solid line is a different color than the second solid line,
wherein the second solid line is raised from the surface of the paper, and
wherein the second writing area is a different color or shade than the first writing area.

54. A writing sheet according to claim 53, wherein the first solid line is green and the second solid line is red.

55. A writing sheet according to claim 54, wherein the dashed line is brown

56. A writing sheet according to claim 53, wherein the second writing area is darker than the first writing area by a Munsell value of at least about 2.

57. A writing sheet according to claim 53, wherein an upper case letter or numeral is depicted in at least one first writing area.

58. A writing sheet according to claim 53, wherein a lower case letter is depicted in at least one first writing area or in at least one first and second adjacent writing areas.

59. A writing sheet according to claim 57, comprising one or more orientation, direction, and/or sequencing indicator(s) to provide assistance for writing the depicted letter.

60. A writing sheet according to claim 58, comprising one or more orientation, direction, and/or sequencing indicator(s) to provide assistance for writing the depicted letter.
